(19) United States
(12) Patent Application Publication
(10) Pub. No.: US 2014/0182484 A1
(43) Pub. Date: Jul. 3, 2014

(54) Process For Producing Polyoxymethylene Polymers With Long-Chain Alkyl End Groups, and Polymers Made Therefrom

(71) Applicant: Ticona GmbH, Sulzbach (Taunus) (DE)

(72) Inventors: Andre Hebel, Sprendlingen (DE); Michael Haubs, Bad Kreuznach (DE); Ursula Ziegler, Mainz-Kostheim (DE)

(73) Assignee: Ticona GmbH, Sulzbach (Taunus) (DE)

(21) Appl. No.: 14/137,763

(22) Filed: Dec. 20, 2013

Related U.S. Application Data
(60) Provisional application No. 61/747,585, filed on Dec. 31, 2012.
(60) Provisional application No. 61/783,379, filed on Mar. 14, 2013.
(60) Provisional application No. 61/747,611, filed on Dec. 31, 2012.
(60) Provisional application No. 61/783,549, filed on Mar. 14, 2013.
(60) Provisional application No. 61/747,550, filed on Dec. 31, 2012.
(60) Provisional application No. 61/783,181, filed on Mar. 14, 2013.

(51) Int. Cl. C08G 65/34

(52) U.S. Cl. CPC C08G 65/34
USPC 106/287.23; 568/600; 568/605

(57) ABSTRACT

A polyoxymethylene polymer is disclosed that contains long-chain alkyl end groups. The polyoxymethylene polymer may be formed by using a Bis-alkylformal as a chain transfer agent during production of the polymer. In one embodiment, the Bis-alkylformal is dissolved in a monomer, such as trioxane, during production of the polymer. In one embodiment, a branching agent may also be present with one or more monomers for producing a branched polyoxymethylene polymer. In this manner, greater amounts of alkyl end groups can be incorporated into the polymer. The resulting polymer has excellent flow characteristics. The polymer may be used to form various molded articles with excellent tribological properties.

### RELATED APPLICATIONS

The present application claims priority to and is based on U.S. Provisional Patent Application Ser. No. 61/747,585, filed on Dec. 31, 2012; U.S. Provisional Patent Application Ser. No. 61/783,379, filed on Mar. 14, 2013; U.S. Provisional Patent Application Ser. No. 61/747,611, filed on Dec. 31, 2012; U.S. Provisional Patent Application No. 61/783,549, filed on Mar. 14, 2013; U.S. Provisional Patent Application No. 61/747,550, filed on Dec. 31, 2012; and U.S. Provisional Patent Application Ser. No. 61/783,181, filed on Mar. 14, 2013, and wherein all of the above identified provisional applications are hereby incorporated by reference.

### BACKGROUND

Acetals, such as formals, are used in many different and numerous applications. Examples of well-known acetals include methylal, dioxolane, paraldehyde, ethylal, butylal, and the like. Acetals can be produced by reacting an alcohol and an aldehyde. In one embodiment, for instance, acetals are produced when a hemiacetal undergoes a condensation reaction.

Acetals, such as formals, are typically miscible with organic solvents. Acetals are used as a solvent for many different components, such as resins and other chemical species. Consequently, in many chemical synthesis acetals are used as carriers, reagents, and solvents in order to facilitate reactions.

Some acetals, such as methylal, are used as a molecular weight regulator during the production of polymers. For instance, methylal is typically used as a molecular weight regulator when producing polyoxymethylene polymers. Other acetals are used as comonomers during the production of polyoxymethylene polymers.

Polyacetal polymers, which are commonly referred to as polyoxymethylenes (POMs), have become established as exceptionally useful engineering materials in a variety of applications. POMs for instance, are widely used in constructing molded parts, such as parts for use in the automotive industry and the electrical industry. POMs, for instance, have excellent mechanical property, fatigue resistance, abrasion resistance, chemical resistance, and moldability.

In the past, various attempts have been made in order to improve the properties of polyoxymethylene polymers by either blending the polymers with various additives or by modifying the polymer chains. For instance, in the past, various end groups have been incorporated into the polyoxymethylene polymer in order to improve one or more properties. For example, JP 06-78671 to Yamamoto entitled “Manufacturing Method For Modified Polyoxymethylene Copolymer” is directed to a manufacturing method in which a primary monomer and a comonomer are copolymerized in the presence of a formal compound having aliphatic hydrocarbon groups. The compound contributes to a chain transfer reaction during a trioxane polymerization reaction and forms the terminal portion in the resulting polymer. JP '671 indicates that no more than one mol/polymer kg of terminal groups are incorporated into the polymer and that the rest of the terminal groups are terminal groups common in the art. JP '671 indicates that the resulting polymer has improved friction properties, sliding properties, and has better compatibility with other additives.

As indicated above, however, the method described in JP '671 is only capable of incorporating limited amounts of the formal compound into the resulting polymer. In view of the above, a need exists for an improved method for incorporating greater amounts of long-chain alkyl groups into a polyoxymethylene polymer. A need also exists for an improved polymer made from the process.

### SUMMARY

In general, the present disclosure is directed to polyoxymethylene polymers that include relatively long-chain alkyl end groups and to a process for producing the polymers. The polyoxymethylene polymer can be used alone or in conjunction with other thermoplastic polymers. The polyoxymethylene polymer with the long-chain alkyl end groups may have improved flowability, slip-wear, and/or additionally other improved properties.

More particularly, the present disclosure is directed to a process that incorporates significant amounts of long-chain alkyl end groups into a polyoxymethylene polymer. The long-chain alkyl end groups, for instance, may have a linear or branched structure and may have a carbon chain length of about 10 carbon atoms or greater, such as about 12 carbon atoms or greater. The present disclosure is also directed to a polyoxymethylene polymer containing the long-chain alkyl end groups in which greater than about 80%, such as greater than about 85%, such as even greater than about 90% of the polymer chains include the alkyl end groups.

In another embodiment, the present disclosure is directed to a process that incorporates long-chain alkyl end groups into a branched polyoxymethylene polymer. The branched polyoxymethylene polymer may comprise a polyoxymethylene homopolymer or a polyoxymethylene copolymer. By having a branched structure, the polyoxymethylene polymer can have more than three terminal groups, such as from about three terminal groups to about ten terminal groups, such as from about three terminal groups to about six terminal groups. Each terminal group can include a long-chain alkyl end group. In this manner, polyoxymethylene polymer molecules can be formed that have at least three end groups comprising a long-chain alkyl end group.

In one embodiment, for instance, the present disclosure is directed to a process for producing a polyoxymethylene polymer. The process includes the steps of combining a monomer that forms —CH₂—O— units with a transfer agent and an initiator. The transfer agent, in accordance with the present disclosure, comprises a Bis-alkylformal. The Bis-alkylformal includes alkyl end groups having a linear or branched carbon chain length of at least 10 carbon atoms, such as at least 12 carbon atoms, such as at least 14 carbon atoms. The monomer is polymerized while the temperature and/or the pressure is raised. Specifically, the temperature and/or the pressure are raised during polymerization an amount sufficient for the Bis-alkylformal to dissolve in the monomer. In this manner, greater amounts of alkyl end groups are formed on the resulting polymer. After polymerization, a deactivator is added for deactivating the polymerization.

In one embodiment, the temperature is raised an amount sufficient so as to form a substantially homogeneous polymer melt during polymerization. Optionally, the polymer melt may be subjected to a hydrolysis step in order to degrade unstable chain ends of the formed polymer. In one embodiment, the hydrolysis step may comprise thermal hydrolysis.

The Bis-alkylformal that is used as the chain transfer agent may have the following formula:

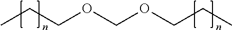

wherein n is from about 10 to about 150, such as from about 10 to about 80, such as from about 12 to about 60. The Bis-alkyformal may comprise Bis-stearylformal and/or Bis-eicosanylformal. In one embodiment, a mixture of Bis-alkylformals may be used as the chain transfer agent.

In one alternative embodiment, one or more monomers that are used to produce the polyoxymethylene polymer may be combined with a branching agent in addition to the transfer agent. The branching agent may be added in amounts sufficient for a branched polyoxymethylene polymer to form. For instance, the formed polymer can have greater than three terminal groups, such as from about three to about ten terminal groups, such as from about three to about six terminal groups. Each terminal group may react with the transfer agent to produce a long-chain alkyl end group. The branching agent, in one embodiment, may comprise an epoxide. Branching agents include polyfunctionalized, such as bifunctionalized, epoxides and polyfunctionalized, such as bifunctionalized, cyclic ethers. In one embodiment, a glycidyl ether may be used as the branching agent. Particular branching agents that may be used include butyldiglycidylether, diglyceroldiformal, and mixtures thereof. The branching agent may be combined with the other monomers in an amount from about 0.5% to about 8% by weight, such as from about 0.1% to about 5% by weight, such as from about 0.1% to about 3% by weight.

In another embodiment, the present disclosure is directed to a polyoxymethylene polymer additive that includes relatively long-chain alkyl end groups. The polyoxymethylene polymer can be used alone or in conjunction with other thermoplastic polymers. When added to other thermoplastic polymers, for instance, the polyoxymethylene additive may function as a flow additive that may also improve tribological properties. The polyoxymethylene polymer when combined with another thermoplastic polymer may include improved flowability, slip-wear, and/or additionally other improved properties of the thermoplastic polymer. In one embodiment, the polyoxymethylene polymer containing the long-chain alkyl end groups is combined with a second polyoxymethylene polymer not containing the long-chain alkyl end groups.

In one embodiment, for instance, the present disclosure is directed to a polymer composition comprising a thermoplastic polymer combined with a flow additive. The flow additive comprises a polyoxymethylene polymer with long-chain alkyl end groups. The long-chain alkyl end groups may have a linear structure or a branched structure and may contain a carbon chain length of at least 10 carbon atoms, such as at least 12 carbon atoms, such as at least 14 carbon atoms, such as at least 16 carbon atoms, such as at least 18 carbon atoms. In one embodiment, the long-chain alkyl end group may comprise a stearyl group, an eicosanyl group, or the like. In one embodiment, the long-chain alkyl end groups comprise a mixture of different long-chain alkyl end groups. In accordance with the present disclosure, the polyoxymethylene polymer with the long-chain alkyl end groups generally has a lower molecular weight, such as less than about 50,000 g/mol. For instance, the molecular weight of the flow additive may be less than about 40,000 g/mol, such as less than about 30,000 g/mol, such as less than about 20,000 g/mol, such as less than about 18,000 g/mol, such as even less than about 15,000 g/mol.

The polyoxymethylene polymer flow additive may contain relatively high amounts of the long-chain alkyl end groups. For instance, the long-chain alkyl end groups may comprise greater than about 5 wt. %, such as greater than about 7.5 wt. %, such as greater than about 10 wt. %, such as greater than about 12.5 wt. %, such as greater than about 15 wt. % of the polymer.

In one embodiment, the long-chain alkyl end groups have the following formula:

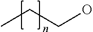

wherein n is from 10 to 150, such as from 12 to 80, such as from 12 to 60.

In one embodiment, the flow additive is a reaction product of a polyoxymethylene polymer and a Bis-alkylformal. The above formal may have the following chemical structure:

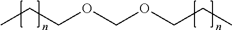

wherein n is from 10 to 150, such as from 10 to 80, such as from 12 to 60. The alkyl end group can be attached to a polyoxymethylene polymer using an ether linkage.

In one embodiment, the attachment of the long-chain alkyl end groups may be represented as follows:

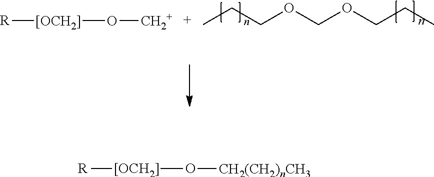

wherein n can be from about 10 to about 150.

In still another embodiment, the present disclosure is directed to a process for producing a particular type of acetal according to a reaction protocol that not only has high conversion rates, but also produces a product with unique characteristics.

More particularly the present disclosure is generally directed to the preparation of acetals and particularly Bis-formals. The Bis-formals include long-chain end groups. The Bis-formals can be produced from long-chain alcohols, such as aliphatic alcohols and/or glycols.

In one embodiment, for instance, the present disclosure is directed to a process for producing a Bis-formal comprising:

combining an alcohol having a hydrocarbon chain length of greater than 10 carbon atoms with a formaldehyde source to form a reaction mixture;

contacting the reaction mixture with a catalyst in order to form a Bis-formal.

In one embodiment, the reaction mixture further contains a solvent. The formaldehyde source may dissolve into the solvent. The catalyst on the other hand, may comprise a heterogeneous catalyst, such as a strongly acidic ion exchange resin.

The process described above can further include the step of collecting the Bis-formal from any remaining reaction mixture. For example, in one embodiment, the reaction mixture can be cooled causing the Bis-formal to precipitate. Once formed into a solid, the Bis-formal can be filtered and separated from any remaining liquids.

Once separated from the reaction mixture, the Bis-formal may be used in numerous and diverse applications. In one embodiment, the formed Bis-formal may proceed through a recrystallization process in order to further purify the product. For example, in one embodiment, the Bis-formal can be washed with a solvent, such as toluene.

In one embodiment, the Bis-formal is formed from an aliphatic alcohol having a hydrocarbon chain length of greater than 10 carbon atoms, such as greater than about 12 carbon atoms, such as greater than about 14 carbon atoms to produce a Bis-alkyformal. The aliphatic alcohol may comprise a single alcohol or a mixture of alcohols. Aliphatic alcohols that may be used in the process include stearyl alcohol, cetyl alcohol, isostearyl alcohol, behenyl alcohol, lignoceryl alcohol, eicosanyl alcohol, and mixtures thereof.

In another embodiment, the present disclosure is generally directed to the preparation of acetals from alkylene glycols, and particularly monomethylated oligo-alkylene glycols. Examples of monomethylated oligo-alkylene glycols include monomethylated oligo-ethylene glycols, monomethylated oligo-propylene glycols, and mixed systems like ethylene-propylene glycols. Of particular advantage, acetals can be produced from the monomethylated alkylene glycols in a single synthetic step with an almost quantitative conversion by reacting the monomethylated alkylene glycol with a formaldehyde source such as paraformaldehyde in a solvent. The reaction is carried out by contacting the reaction mixture with a catalyst, in particularly an acidic ion exchange resin. Water formed during the reaction can be easily removed to produce the product.

In one embodiment, for instance, the present disclosure is directed to a process for producing a Bis-polyalkylene glycol-formal comprising:

combining a polyalkylene glycol with a formaldehyde source to form a reaction mixture;

contacting the reaction mixture with a catalyst in order to form a Bis-polyalkylene glycol-formal.

In one embodiment, the reaction mixture further contains a solvent. The formaldehyde source may dissolve into the solvent. The catalyst on the other hand, may comprise a heterogeneous catalyst, such as a strongly acidic ion exchange resin. The polyalkylene glycol can comprise a monomethylated alkylene glycol having a molecular weight of from about 350 to about 10,000 g/mole, such as from about 500 to about 5000, such as about 500 to about 1500.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

In one aspect, the present disclosure is directed to a process for producing acetals, and particularly Bis-formals. Of particular advantage, the formals produced according to the present disclosure constitute relatively long chain end groups. For instance, the formals can be produced from long-chain alcohols, such as aliphatic alcohols or long-chain glycols. The formals can be used to produce polyoxymethylene polymers.

In this regard, the present disclosure is also directed to a polyoxymethylene polymer having relatively long-chain alkyl end groups. In one embodiment, the polymer is formed by reacting a polyoxymethylene polymer or oligomer with a Bis-alkylformal. The above formal can be added during production of the polyoxymethylene polymer and can serve as a molecular weight regulator or chain transfer agent during production of the polymer. The relatively long-chain alkyl end groups on the polyoxymethylene polymer can be attached to the polymer via an ether linkage. In one embodiment, the alkyl end groups have a molecular weight of greater than about 200 g/mol.

The long-chain alkyl end groups that are attached to the polyoxymethylene polymer may have a linear structure or a branched structure. The polyoxymethylene polymer itself may also have a linear structure or a branched structure. The alkyl end groups can have a carbon chain length of at least 10 carbon atoms, such as at least 12 carbon atoms, such as at least 14 carbon atoms, such as at least 18 carbon atoms. The carbon chain length of the alkyl end groups, for instance, may be from about 10 carbon atoms to about 150 carbon atoms, such as from about 12 carbon atoms to about 100 carbon atoms, such as from about 12 carbon atoms to about 80 carbon atoms, such as from about 12 carbon atoms to about 60 carbon atoms.

The long-chain alkyl end groups attached to the polyoxymethylene polymer chain may all comprise the same alkyl groups or may comprise different alkyl groups. As will be described in greater detail below, for instance, a mixture of Bis-alkylformals may be used to produce the polymer which will result in a polyoxymethylene polymer in which a majority of the polymer chains all contain a long-chain alkyl end group, but wherein the alkyl end groups can vary from molecule to molecule. In this manner, a polyoxymethylene polymer can be produced in which a proportion of the polymer contains, for instance, linear long-chain alkyl groups, while another proportion can contain branched long-chain alkyl end groups. In still another embodiment, a polyoxymethylene polymer may be produced wherein all of the end groups comprise linear long-chain alkyl end groups but wherein the chain length varies from molecule to molecule. For example, in one embodiment, a polyoxymethylene polymer can be produced in which the polymer includes at least two different long-chain alkyl end groups, such as linear alkyl end groups having a carbon chain length of 12 carbon atoms, 18 carbon atoms, 20 carbon atoms, 22 carbon atoms, 24 carbon atoms, and/or 28 carbon atoms.

As will be discussed in greater detail below, the present disclosure is directed to a process in which substantial amounts of the alkyl end groups are incorporated into the polyoxymethylene polymer. For instance, in accordance with the present disclosure, a polyoxymethylene polymer can be produced in which at least 80%, such as at least 85%, such as even at least 90% of the polymer contains the long-chain alkyl end groups. By incorporating a significant amount of alkyl end groups into the polymer, various advantages and benefits are obtained. For instance, by incorporating greater amounts of the long-chain alkyl end groups into the polymer, a polyoxymethylene polymer is produced with improved flow properties. For instance, the polyoxymethylene polymer can have a melt viscosity that is significantly lower in comparison to a substantially identical polyoxymethylene polymer not containing the long-chain alkyl end groups but having the same molecular weight (such as a polyoxymethylene polymer produced with methylal as the chain transfer agent).

In one embodiment, the present disclosure is directed to using the above polyoxymethylene polymer as an additive, such as a flow additive or lubricant for another polymer, such as another polyoxymethylene polymer.

Although the long-chain alkyl end groups can have a relatively high molecular weight, in one embodiment, the overall molecular weight of the polyoxymethylene polymer when used as an additive can be relatively low. For example, the molecular weight of the polyoxymethylene additive can be less than about 50,000 g/mol, such as less than about 40,000 g/mol, such as less than about 30,000 g/mol, such as less than about 20,000 g/mol, such as less than about 18,000 g/mol, such as less than about 15,000 g/mol. The molecular weight of the polyoxymethylene additive is generally greater than about 2,000 g/mol, such as greater than about 4,000 g/mol.

As used herein, the molecular weight of the polymer is the weight average molecular weight of the polymer (Mw). The weight average molecular weight of the polymer can be determined using techniques well known in the art. For instance, in one embodiment, the molecular weight can be determined using gel permeation chromatography.

When used as an additive, the polyoxymethylene polymer containing the relatively long-chain alkyl end groups of the present disclosure can be combined with various thermoplastic polymers. The polyoxymethylene flow additive can have a beneficial impact on the flow properties of the polymer allowing the polymer to be more easily melt processed. In one embodiment, for instance, the flow additive of the present disclosure can increase the melt-volume flow rate of the thermoplastic polymer. Ultimately, the flow additive can improve the flow characteristics of the thermoplastic polymer when the polymer is heated and fed through a molding process, such as an injection molding process, a blow molding process or any suitable extrusion process.

For example, in one embodiment, the flow additive of the present disclosure can increase the melt volume flow rate of a thermoplastic polymer by at least about 5%, such as by at least about 10%, such as even by at least about 15%. In one embodiment, the flow additive can increase the melt volume flow rate by greater than about 20%, such as greater than about 25%, such as greater than about 30%, such as greater than about 35%, such as greater than about 40%.

Enhancing the flow characteristics of the thermoplastic polymer may have numerous benefits. For instance, the thermoplastic polymer may be processed at lower temperatures in certain applications allowing for faster cooling rates while minimizing thermal decomposition of the polymer. Molded articles can also be produced with more uniform properties. When present, the flow additive may allow the thermoplastic polymer to be more easily molded into complex shapes.

The flow additive of the present disclosure can be used with any suitable thermoplastic polymer. In one embodiment, for instance, the polyoxymethylene flow additive may be used in combination with a thermoplastic polymer that is highly crystalline. For instance, the thermoplastic polymer may be at least 30% crystalline, such as at least 50% crystalline, such as from about 50 to about 70% crystalline.

In one embodiment, the polyoxymethylene flow additive is combined with another polyoxymethylene polymer. The other polyoxymethylene polymer, for instance, may comprise a polyoxymethylene homopolymer or copolymer that does not contain the long-chain alkyl end groups. Of particular advantage, combining the polyoxymethylene flow additive with another polyoxymethylene polymer can improve the flow properties of the polyoxymethylene polymer without adversely impacting the physical properties of the polyoxymethylene polymer such as the strength properties.

In addition to polyoxymethylene polymers, the flow additive of the present disclosure may combine with various other thermoplastic polymers. Such polymers include polyesters, polyamides, polyolefins, and the like.

In addition to having improved melt flow properties and/or being used as an additive, polyoxymethylene polymers made in accordance with the present disclosure can also have improved tribological characteristics. The polyoxymethylene polymer may also have increased surface energy compared to other conventional polyoxymethylene polymers.

In one embodiment, a branched polyoxymethylene polymer may be modified in accordance with the present disclosure to contain long-chain alkyl end groups. By using a branched polymer, a greater number of long-chain alkyl end groups may be incorporated into each polymer molecule. In fact, when using a branched polyoxymethylene polymer, the above described advantages regarding the melt flow properties and the tribological properties of the polymer can even be further enhanced. For instance, using a branched polyoxymethylene polymer allows for the incorporation of higher concentrations of long-chain alkyl end groups. The higher concentration of long-chain alkyl end groups can also occur without a negative influence on the viscosity and the molecular weight of the polyoxymethylene polymer. By incorporating a higher concentration of long-chain alkyl end groups into the polyoxymethylene polymer, the resulting polymer can display further improved tribological properties.

In order to form a polyoxymethylene polymer containing long-chain alkyl end groups in accordance with the present disclosure, in one embodiment, a Bis-alkylformal, and particularly, a Bis-long-chain alkylformal is used as a comonomer, a chain transfer agent, and/or a molecular weight regulator during production of the polymer in order to yield a polyoxymethylene polymer having long-chain alkyl end groups. In one embodiment, a branching agent can also be combined with the one or more monomers during formation of the polyoxymethylene polymer. The polyoxymethylene polymer that is formed can be tailored to exhibit particular qualities, such as melt-flow properties, mechanical characteristics, thermal characteristics, etc.

In one embodiment, the attachment of the long-chain alkyl end groups may be represented as follows:

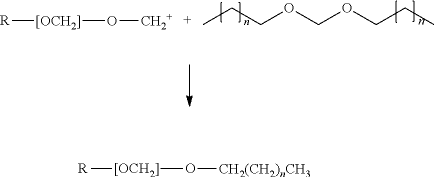

wherein n can be from about 10 to about 150.

In order to incorporate relatively great amounts of the long-chain alkyl end groups into the polyoxymethylene polymer, in one embodiment, the Bis-alkylformal is dissolved in one or more monomers that are used to produce the polymer. For instance, in one embodiment in accordance with the present disclosure, the Bis-alkylformal is dissolved in trioxane either prior to polymerization or during polymerization. In order to increase the amount of Bis-alkylformal dissolved in the monomer, the temperature and/or pressure can be increased. Ultimately, a polyoxymethylene polymer can be produced wherein greater than 80%, such as greater than 85% of the polymer includes the long-chain alkyl end groups.

The polyoxymethylene can be either an oxymethylene homopolymer or copolymer and is not limited as to any particular monomeric components or relative amounts of monomeric components. For instance, the polyoxymethylene can be a conventional oxymethylene homopolymer and/or oxymethylene copolymer. Conventional polyoxymethylenes are generally unbranched linear polymers that contain greater than about 80%, or greater than about 90%, oxymethylene units (—CH₂O—). The polyoxymethylene is not limited to this level of oxymethylene units, however, and polymers including lower content of oxymethylene units are also encompassed herein. According to one embodiment, the polyoxymethylene can be a homo- or copolymer which comprises greater than about 50 mol %, greater than about 75 mol %, greater than about 90 mol %, or greater than about 95 mol % —CH₂— repeat units.

In one embodiment, the polyoxymethylene polymer may comprise a branched polymer. In one embodiment, a branched polyoxymethylene polymer may be modified in accordance with the present disclosure to contain long-chain alkyl end groups. By using a branched polymer, a greater number of long-chain alkyl end groups may be incorporated into each polymer molecule. In fact, when using a branched polyoxymethylene polymer, the above described advantages regarding the melt flow properties and the tribological properties of the polymer can even be further enhanced. For instance, using a branched polyoxymethylene polymer allows for the incorporation of higher concentrations of long-chain alkyl end groups. The higher concentration of long-chain alkyl end groups can also occur without a negative influence on the viscosity and the molecular weight of the polyoxymethylene polymer. By incorporating a higher concentration of long-chain alkyl end groups into the polyoxymethylene polymer, the resulting polymer can display further improved tribological properties.

The branched polymer may also contain greater than about 80%, such as greater than about 90% of oxymethylene units. In order to produce the branched polymer, a branching agent may be combined with the monomers used to form the polymer. A branched polyoxymethylene polymer may contain greater than three, such as from about three to about ten, such as from about three to about six terminal groups. By incorporating a greater amount of terminal groups in the polymer, the polymer is capable of including a greater concentration of long-chain alkyl end groups. By increasing the concentration of long-chain alkyl end groups, viscosity properties may be improved, tribological properties of the polymer may be improved, and various other benefits and advantages may be obtained.

Polyoxymethylenes encompass both homopolymers of formaldehyde or its cyclic oligomers, such as trioxane or 1,3,5,7-tetraoxacyclooctane, and corresponding copolymers. By way of example, the following components can be used in any suitable proportional relationship in the polymerization process: ethyleneoxide, 1,2-propyleneoxide, 1,2-butyleneoxide, 1,3-butyleneoxide, 1,3-dioxane, 1,3-dioxolane, 1,3-dioxepane and 1,3,6-trioxocane as cyclic ethers as well as linear oligo- or polyformals, like polydioxolane or polydioxepane. Further, conventional functionalized polyoxymethylenes that are prepared by copolymerization of trioxane and the formal of trimethylolpropane (ester), of trioxane and the α,α- and the α,β-isomers of glyceryl formal (ester) or of trioxane and the formal of 1,2,6-hexantriol (ester) can be used as the polyoxymethylene. An oxymethylene copolymer can generally include greater than about 0.1% by weight of monomer units of the copolymer having at least two adjacent carbon atoms. By way of example, an oxymethylene copolymer can include from about 1% to about 10% by weight of monomer units having two or more adjacent carbon atoms. Such conventional oxymethylene homo- or copolymers are known to the person skilled in the art and are described in the literature.

In one embodiment, an oxymethylene copolymer can include up to about 50 mol %, for instance from about 0.1 mol % to about 20 mol %, or from about 0.3 mol % to about 10 mol %, of repeat units having the following structure:

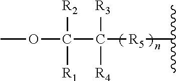

wherein
R₁ to R₄, independently of one another, are hydrogen, alkyl, or halogen-substituted alkyl having from 1 to 4 carbon atoms,
R₅ is —CH₂—, —CH₂O—, C1-C4-alkyl- or C1-C4-haloalkyl-substituted methylene, or a corresponding oxymethylene group, and
n is from 0 to 3.

These groups may be introduced into the copolymers by the ring-opening of cyclic ethers. Cyclic ethers can include those of the formula:

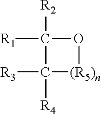

where R¹ to R⁵ and n are as defined above.

Cyclic ethers which may be mentioned as examples are ethylene oxide, propylene 1,2-oxide, butylene 1,2-oxide, butylene 1,3-oxide, 1,3-dioxane, 1,3-dioxolane, and 1,3-dioxepan, and comonomers which may be mentioned as examples are linear oligo- or polyformals, such as polydioxolane or polydioxepane.

Use can also be made of oxymethylene terpolymers, for example those prepared by reacting trioxane with one of the abovementioned cyclic ethers and with a third monomer, for instance a bifunctional compound of the formula

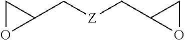

where

Z is a chemical bond, —O— or —ORO— (R=C1-C8-alkylene or C2-C8-cycloalkylene).

Monomers of this type can include, without limitation, ethylene diglycide, diglycidyl ether, and diethers composed of glycidyl units and formaldehyde, dioxane, or trioxane in a molar ratio of 2:1, and also diethers composed of 2 mol of glycidyl compound and 1 mol of an aliphatic diol having from 2 to 8 carbon atoms, for example the diglycidyl ethers of ethylene glycol, 1,4-butanediol, 1,3-butanediol, 1,3-cyclobutanediol, 1,2-propanediol, or 1,4-cyclohexene diol, to mention just a few examples.

In one embodiment, a branching agent may be combined with the one or more monomers used to produce the polyoxymethylene polymer in order to form a branched polymer (as opposed to a linear polymer). In one embodiment, the branching agent may comprise the third monomer as described above. For instance, an epoxide, such as a glycidyl ether can serve as a branching agent. In one embodiment, the branching agent may comprise a polyfunctionalized epoxide, such as a bifunctionalized epoxide, and/or a polyfunctionalized cyclic ether, such as a difunctionalized cyclic ether. For instance, the branching agent may comprise a diglycidylether, such as an alkyldiglycidylether. Alternatively, the branching agent may comprise a dialcoholdiformal or a dipolyoldiformal.

In particular embodiments, the branching agent may comprise butyldiglycidylether (BDGE), diglyceroldiformal (DGDF), or mixtures thereof. It should be understood, however, that the above examples of branching agents are provided for illustration only and that many other glycidyl ethers and diformals may be used.

When present during formation of the polyoxymethylene polymer, the branching agent can be added to the other monomers in an amount from about 0.05% to about 8% by weight, such as from about 0.1% to about 5% by weight, such as from about 0.1% to about 3% by weight, based upon the total weight of all monomers present including the transfer agent. Generally speaking, a branching agent is combined with the other monomers in an amount sufficient to produce a branched polymer. The resulting polymer can have, for instance, greater than three terminal groups per molecule. For instance, the resulting polymer can have greater than three terminal groups per polymer, such as greater than four terminal groups per polymer, such as greater than about five terminal groups per polymer, such as greater than about six terminal groups per polymer. In general, the branched polymer will contain less than about twelve terminal groups, such as less than about ten terminal groups, such as less than about eight terminal groups, such as less than about six terminal groups per molecule.

The thermal properties of a branched polymer made in accordance with the present disclosure may differ from the thermal properties of a linear polymer containing the long-chain alkyl groups. For instance, branched polymers containing the long-chain alkyl groups may have a higher melting point and a higher degree of crystallinity.

The polyoxymethylene can be a low, mid- or high molecular weight polyoxymethylene. In one embodiment, the polyoxymethylene can have a melt flow index (MFI) ranging from about 1 to about 150 g/10 min, as determined according to ISO 1133 at 190° C. and 2.16 kg, though polyoxymethylenes having a higher or lower melt flow index are also encompassed herein. For example, the polyoxymethylene polymer may be a low or mid-molecular weight polyoxymethylene that has a melt flow index of greater than about 5 g/10 min, greater than about 10 g/10 min, or greater than about 15 g/10 min. The melt flow index of the polyoxymethylene polymer can be less than about 25 g/10 min, less than about 20 g/10 min, less than about 18 g/10 min, less than about 15 g/10 min, less than about 13 g/10 min, or less than about 12 g/10 min. The polyoxymethylene polymer may for instance be a high molecular weight polyoxymethylene that has a melt flow index of less than about 5 g/10 min, less than about 3 g/10 min, or less than about 2 g/10 min.

Incorporating the relatively long-chain alkyl end groups into the polyoxymethylene polymer, as described above, can improve flowability, slip-wear and various other properties. Of particular advantage, for instance, a relatively high molecular weight polyoxymethylene polymer can be produced that has improved melt-flow properties.

The preparation of the polyoxymethylene can be carried out by polymerization of polyoxymethylene-forming monomers, such as trioxane or a mixture of trioxane and dioxolane and/or butanediol formal in the presence of a Bis-alkylformal and optionally in the presence of a branching agent in accordance with the present disclosure. The polymerization can be effected as precipitation polymerization and/or in the melt. For instance, the polyoxymethylene polymer may be produced through a heterogeneous polymerization process. Alternatively, the polymer may be produced through a homogeneous polymerization process during which polymerization occurs in the molten phase. In yet another embodiment, the polymer can be produced through a combination of heterogeneous polymerization and homogeneous polymerization.

Initiators which may be used are the compounds known per se, including either anionic or cationic initiators such as trifluoromethane sulfonic acid; these can be added as solution in ethylene glycol to the monomer. By way of example, a polyoxymethylene homopolymers can be formed via anionic polymerization according to known methods. By a suitable choice of the polymerization parameters, such as duration of polymerization and/or amount of molecular weight regulator, the molecular weight and hence the melt flow index value of the resulting polymer can be adjusted. The above-described procedure for the polymerization leads as a rule to polymers having comparatively small proportions of low molecular weight constituents. If a further reduction in the content of low molecular weight constituents were to be desired or required, this can be affected by separating off the low molecular weight fractions of the polymer after the deactivation and the degradation of the unstable fractions after treatment with a basic protic solvent. This may be a fractional precipitation from a solution of the stabilized polymer, polymer fractions of different molecular weight distribution being obtained.

In one embodiment, significant amounts of the Bis-alkylformal can be added during polymerization in order to lower the molecular weight of the resulting polymer. In one embodiment, for instance, the resulting product can have a molecular weight of below 50,000 g/mol.

In one embodiment, a polyoxymethylene can be produced using a cationic polymerization process, optionally followed by hydrolysis to remove any unstable end groups. Cationic initiators as are generally known in the art can be utilized such as Lewis acids, and in one particular embodiment, boron trifluoride.

According to one formation process, the polyoxymethylene forming monomers can be polymerized in the presence of one or more heteropolyacids. It has been discovered that the low molecular weight constituents can be significantly reduced by conducting the polymerization using a heteropolyacid such as phosphotungstic acid as the catalyst. When using a heteropolyacid as the catalyst, for instance, the amount of low molecular weight constituents can be less than 2% by weight.

The term “heteropolyacid” is a generic term for a polyacid formed by the condensation of different kinds of oxo acids through dehydration. A heteropolyacid contains a mono- or poly-nuclear complex ion wherein a hetero element is present in the center and the oxo acid residues are condensed through oxygen atoms. Such a heteropolyacid is represented by the formula:

Hₓ[MₘM′ₚO_{z}]yH₂O

wherein
M represents an element selected from the group consisting of P, Si, Ge, Sn, As, Sb, U, Mn, Re, Cu, Ni, Ti, Co, Fe, Cr, Th and Ce,
M′ represents an element selected from the group consisting of W, Mo, V and Nb,
m is 1 to 10,
p is 6 to 40,
z is 10 to 100,
x is an integer of 1 or above, and
y is 0 to 50.

The central element (M) in the formula described above may be composed of one or more kinds of elements selected from P and Si and the coordinate element (M′) is composed of at least one element selected from W, Mo and V.

Specific examples of heteropolyacids include those selected from the group consisting of phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstovanadic acid and acid salts thereof.

The heteropolyacid may be dissolved in an alkyl ester of a polybasic carboxylic acid. It has been found that alkyl esters of polybasic carboxylic acid are effective to dissolve the heteropolyacids or salts thereof at room temperature (25° C.).

Examples of the alkyl ester of a polybasic carboxylic acid can include, but are not limited to, dimethyl glutaric acid, dimethyl adipic acid, dimethyl pimelic acid, dimethyl suberic acid, diethyl glutaric acid, diethyl adipic acid, diethyl pimelic acid, diethyl suberic acid, diemethyl phthalic acid, dimethyl isophthalic acid, dimethyl terephthalic acid, diethyl phthalic acid, diethyl isophthalic acid, diethyl terephthalic acid, butantetracarboxylic acid tetramethylester and butantetracarboxylic acid tetraethylester as well as mixtures thereof. Other examples include dimethylisophthalate, diethylisophthalate, dimethylterephthalate or diethylterephthalate.

In one embodiment, the polyoxymethylene polymer is produced in a first phase that comprises a heterogeneous polymerization followed in a second phase by a homogeneous polymerization. For instance, in one embodiment, the polyoxymethylene polymer is produced according to the following process:

i) polymerization of a monomer that forms —CH₂—O— units and which, if appropriate, comprises a cyclic acetal, such as, for example, dioxolane in the presence of a transfer agent and optionally a branching agent in accordance with the present disclosure and of an initiator for cationic polymerization, where the temperature of the polymerization mixture is so low that solid polymer is present alongside liquid monomer at the beginning of the polymerization,

ii) raising of the temperature during the course of the polymerization sufficiently far that a substantially homogeneous polymer melt is present at the end of the polymerization alongside remaining residual monomers,

iii) deactivation of the active polymer chains in a homogeneous phase, in that the polymer melt is brought into contact with a deactivator,
and

iv) if appropriate, direct further processing of the resultant melt via degradation of the unstable chain ends and devolatilization of the polymer melt.

In one preferred embodiment, the process takes place, at least in the homogeneous reaction step, in a sealed system, that is to say that the reaction takes place under the pressure generated by the monomers themselves, e.g. trioxane or formaldehyde.

The first phase of the inventive process, for example step i), is the known polymerization of monomers that form —CH₂—O— units, if appropriate in the presence of cyclic acetals, such as 1,3-dioxolane. The polymerization takes the form of a precipitation polymerization, and solid polymer is therefore present alongside monomer which has not yet been consumed. For this, a monomer that forms —CH₂—O— units, or a mixture of different monomers, is reacted using conventional initiators for cationic polymerization and using a chain transfer agent and optionally a branching agent in accordance with the present disclosure. In particular, the chain transfer agent comprises a Bis-alkylformal. Typical temperatures are from 40° C. to 150° C. The polymerization preferably takes place at pressures of from 2 to 100 bar, preferably at pressures of from 5 to 40 bar.

The polymerization temperature in this first phase is sufficiently low that the polymer substantially precipitates in the reaction mixture, i.e. the reaction mixture is a heterogeneous solid/liquid mixture. The solid phase here is formed by precipitated polymer, while the liquid phase is in essence composed of as yet unconverted monomer. The polymerization conversion is from 10% to 80%, and a conveyable mixture is therefore present.

In the second phase of the process, following the first phase, for example in step ii), the polymerization temperature rises in such a way that the heterogeneous solid/liquid mixture becomes substantially homogeneous. The temperature rise is brought about on the one hand via the heat of polymerization/crystallization, and on the other hand via heat supply from outside. This enables the polymerization to be carried out with a certain temperature profile. A controlled temperature profile permits adjustment as desired of some of the properties of the polymers, examples being impact resistance or modulus of elasticity, within certain limits. The controlled utilization of the heat of polymerization/crystallization permits efficient utilization of energy in this step of the process. On the other hand, it is also possible to achieve other temperature profiles for the purposes of the process via appropriate heating elements and cooling elements.

In one embodiment, the temperature and/or pressure during polymerization is increased an amount sufficient for the Bis-alkylformal to dissolve in one of the monomers, such as the primary monomer. For instance, in one embodiment, the temperature can be increased to greater than about 120° C., such as greater than about 130° C., for the Bis-alkylformal to dissolve in trioxane.

The temperature profile over the entire polymerization typically varies from 80° C. to 170° C., but can also run from 120° C. to 180° C. The temperature and residence time in the second phase are minimized, in order to suppress undesired side-reactions (hydride shift). Typical upper temperatures—as a function of comonomer content—are from 100° C. to 170° C., and this temperature or final temperature is to be adjusted according to the invention in such a way that the reaction mixture is substantially homogeneous, i.e. the polymer is molten.

At the end of the second phase of the inventive process, for example in step iii), to terminate the polymerization, the homogeneous, liquid reaction mixture, which can comprise, if appropriate, small amounts of solid constituents and which still comprises unconverted monomers, such as trioxane and formaldehyde, alongside polymer, is brought into contact with deactivators. These can be in bulk form or in a form diluted with an inert aprotic solvent when they are admixed with the polymerization mixture. The result is rapid and complete deactivation of the active chain ends. It has been found that the polymerization can be terminated even when the liquid polymerization mixture at the end of the polymerization is substantially, but not necessarily completely, molten. It is therefore possible to terminate the polymerization via addition of deactivators when the polymerization mixture still comprises from about 5 to 10% by weight of solid constituents.

The optional step iv) corresponds to melt hydrolysis. The polymers can be introduced directly in the form of melt into the assemblies that follow.

In one preferred embodiment of the process, operation in a sealed assembly permits the conduct of the reaction at temperatures above the boiling point of the monomers. This also leads to better yields in the polymerization, since the monomers cannot escape.

In one preferred embodiment, the first and second phase of the process are carried out in a reactor which permits the generation of a superatmospheric pressure in the interior of the reactor during continuous introduction of reactants into the reactor and continuous discharge of materials from the reactor, and which possesses a plurality of mutually independently heatable zones.

This reactor is particularly preferably an extruder with pressure-retention valve which has connection to the outlet of the extruder.

For the preparation of the oxymethylene polymers, a monomer that forms —CH₂—O— units, or a mixture of different monomers, is reacted in the manner described above. Examples of monomers that form —CH₂—O— units are formaldehyde or its cyclic oligomers, such as 1,3,5-trioxane (trioxane) or 1,3,5,7-tetroxane.

In accordance with the present disclosure, the chain transfer agent used during the process comprises a Bis-alkyformal or a mixture of Bis-alkylformals. In accordance with the present disclosure, the alkyl groups contained in the Bis-alkylformal have long carbon chains. For instance, the carbon chain length can be at least 10 carbon atoms, such as at least 12 carbon atoms, such as at least 14 carbon atoms, such as at least 16 carbon atoms, such as at least about 18 carbon atoms. The alkyl groups can have a linear structure or a branched structure. In one particular embodiment, the chain transfer agent has the following chemical structure:

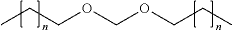

wherein n is from about 10 to about 150, such as from about 10 to about 80, such as from about 12 to about 60.

In order to produce the chain transfer agent, in one embodiment, a long-chain aliphatic alcohol can be reacted with a formaldehyde source.

Examples of long-chain alcohols, for instance, may comprise fatty alcohols. The long-chain alcohols can have a linear structure or a branched structure. In one embodiment, a long-chain aliphatic alcohol is used that has a hydrocarbon chain length of greater than 10 carbon atoms, such as greater than about 12 carbon atoms, such as greater than about 14 carbon atoms. The hydrocarbon chain length of the aliphatic alcohol can generally be less than 150, such as less than about 80, such as less than about 60. In one embodiment, an aliphatic alcohol is selected such that the resulting Bis-alkylformal produced from the alcohol is a solid or gel at a temperature of less than about 80° C., such as less than about 70° C., such as less than about 60° C., such as less than about 50° C., such as less than about 40° C., such as less than about 30° C. When a solid or gel is produced, for instance, the Bis-alkylformal can be easily separated from the remaining reaction products.

In another embodiment, the formals can be produced from oligo-alkylene glycols, particularly monomethylated oligo-alkylene glycols. The oligo-alkylene glycols include monomethylated oligo-ethylene glycols, monomethylated oligo-propylene glycols and mixed systems including oligo-ethylene-propylene glycols.

Of particular advantage, the formals can be produced in a single step reaction. Not only is the reaction relatively fast and economical, but is very efficient producing relatively high conversion rates. In one embodiment, for instance, the formals are produced by reacting a formaldehyde source such as paraformaldehyde, with a long-chain aliphatic alcohol. The reaction occurs in the presence of a solvent that can act as an entrainer for water produced during the reaction. The reaction is catalyzed using, in one embodiment, an acidic ion exchange resin as the catalyst. The resulting product can have wax-like properties and therefore can be easily separated and isolated for use in numerous applications. In fact, the resulting product can be used without any further purification steps. In one embodiment, for instance, the reaction is a single step reaction that is driven to high conversions, such as conversions greater 95%.

In one embodiment, the reaction can be shown as follows:

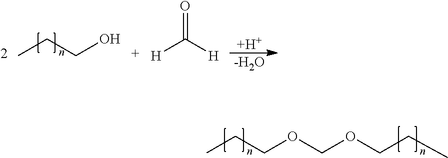

where n is greater than about 10, such as greater than about 12, such as greater than about 14. For instance, n can be from about 10 to about 150, such as from about 12 to about 80, such as from about 16 to about 60, such as from about 18 to about 50.

As shown above, a long-chain alcohol is reacted with a formaldehyde source. The long-chain alcohol generally comprises a long-chain aliphatic alcohol. The long-chain alcohol, for instance, can have a hydrocarbon chain length of greater than about 10 carbon atoms, such as greater than about 12 carbon atoms. The long-chain alcohol may have a linear structure or a branched structure. Further, a mixture of alcohols can be used to produce the alkylformal which will result in the production of a mixture of different alkylformals. The mixture of long-chain alcohols used to produce the Bis-alkylformals may comprise alcohols all with a linear structure, all with a branched structure, or may comprise a mixture of alcohols with linear and branched structures.

Examples of long-chain aliphatic alcohols that may be used in the process of the present disclosure include C₁₀ to C₈₀ saturated fatty alcohols. Particular examples of alcohols include capric alcohol, undecyl alcohol, lauryl alcohol, tridecyl alcohol, myristyl alcohol, pentadecyl alcohol, cetyl alcohol, heptadecyl alcohol, stearyl alcohol, isostearyl alcohol, nonadecyl alcohol, eicosanyl alcohol, heneicosyl alcohol, behenyl alcohol, lignoceryl alcohol, ceryl alcohol, 1-heptacosanol, montanyl alcohol, cluytyl alcohol, 1-nonacosanol, myricyl alcohol, melissyl alcohol, 1-dotriacontanol, geddyl alcohol, cetearyl alcohol, and mixtures thereof.

As described above, in one embodiment, a mixture of aliphatic alcohols may be used to produce a mixture of Bis-alkylformals. Mixtures of long-chain aliphatic alcohols, for instance, are commercially available under the trade name NAFOL. In one embodiment, for instance, a mixture of long-chain alcohols can be used that includes 1-octadecan, 1-eicosan, and 1-docosan. In another embodiment, a mixture of long-chain alcohols may be used that include cetyl alcohol combined with octadecanol. In still another embodiment, a mixture of long-chain alcohols is used that includes a C₁₈ alcohol, a C₂₀ alcohol, a C₂₂ alcohol, and optionally a C₂₄ alcohol.

In an alternative embodiment, the formals are produced by reacting a formaldehyde source such as paraformaldehyde, with a monomethylated oligo-alkylene glycol having a mean molecular weight of greater than about 350 g/mole, such as from about 350 g/mole to about 10,000 g/mole. The reaction occurs in the presence of a solvent that can act as an entrainer for water produced during the reaction. The reaction is catalyzed using, in one embodiment, an acidic ion exchange resin as the catalyst. The resulting product has wax-like properties and therefore can be easily separated and isolated for use in numerous applications. In fact, the resulting product can be used without any further purification steps. In one embodiment, for instance, the reaction is a single step reaction that is driven to high conversions, such as conversions greater 95%.

In one embodiment, the reaction according to the present disclosure can be shown as follows:

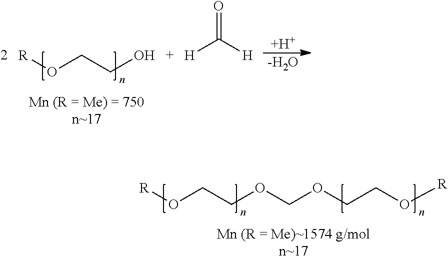

where R=H, linear or branched alkyl groups, e.g. methyl (Me); and

where n is greater than about 10, such as greater than about 12, such as greater than about 14. For instance, n can be from about 10 to about 150, such as from about 12 to about 80, such as from about 12 to about 60, such as from about 12 to about 50.

As shown above, an alkylene glycol is reacted with a formaldehyde source. The alkylene glycol generally comprises an oligo-alkylene glycol, particularly a monomethylated oligo-alkylene glycol. The monomethylated oligo-alkylene glycol can comprise an ethylene glycol, propylene glycol, or a mixture of both. As also shown above, the alkylene glycol can be associated with a linear or branched alkyl group. In general, the alkyl group associated with the alkylene glycol can have a chain length of less than about 80 carbon atoms, such as less than about 50 carbon atoms, such as less than about 30 carbon atoms, such as less than about 10 carbon atoms. In one embodiment, the alkyl group associated with the alkylene glycol is a methyl or ethyl group.

Suitable polyethylene glycol methyl ethers (MPEG), such as PEG-550-M, PEG-750-M or PEG-1000-M, that are derived from polyethylene glycols (PEG) are commercially available, usually as mixtures of oligomers characterized by an average molecular weight. In one embodiment, polyethylene glycol fragments of the MPEG have an average molecular weight from about 500 to about 1500, and those having an average molecular weight from about 600 to about 900, and those having an average molecular weight of about 750 being particularly preferred. Both linear and branched PEG molecules can be used.

Although most sources of MPEG (and PEG) are characterized as a range of compounds based on the number of polyethyleneoxide subunits, narrower ranges are also available (commercially and otherwise) based on a controlled polymerization of ethylene oxide. These more narrowly dispersed MPEGs (and PEGs) are also included in this application.

Each MPEG (and PEG), being a broad range of compounds varying in molecular weight as a function of the number of PEG units, is also subject to peak shaving, where either lower or higher molecular weight components are removed on either or both sides of the central, predominant component (e.g., by chromatographic separation). Such MPEG (or PEG) compositions are also fully amenable to the syntheses of the lubricant disclosed herein. Representative ranges, for example, below and above the center for MPEG-550 would be MPEG-450 to MPEG-650; for MPEG-750, a range of MPEG-650 to MPEG-850; and for MPEG-1000, a range of MPEG-850 to MPEG-1200. Various combinations and permutations of two or more MPEGs (and PEGs) could be pre-formed, in any ratio. The chemistry routes as described within this application apply equally well to any and all such mixtures of MPEGs (or PEGs).

As explained above, the monomethylated alkylene glycol for use in the present disclosure can generally have a relatively high molecular weight such as greater than about 350 g/mole, such as from about 350 g/mole to about 10,000 g/mole such as from about 500 g/mole to about 5,000 g/mole. Using higher molecular weight monomethylated alkylene glycols provides numerous advantages and benefits. For instance, the formals produced from these materials, have unique characteristics that allow the formals to be used in many diverse applications, such as a monomer for attaching functional groups to polymer chains. The longer chain alkylene glycols also produce a product that can be easily separated and isolated after the reaction.

The relatively high molecular weight aliphatic alcohol is reacted with a formaldehyde source. The formaldehyde source can comprise any suitable formaldehyde source capable of producing the desired formal. In one embodiment, the formaldehyde source may comprise paraformaldehyde. The paraformaldehyde can have a water content of less than about 5-wt %, such as less than about 2-wt %, such as less than about 1-wt %.

In other embodiments, different formaldehyde sources may be used. For instance, the formaldehyde source may comprise formaldehyde, such as gaseous formaldehyde or an aqueous solution of formaldehyde. In still another embodiment, the formaldehyde source may comprise a polyoxymethylene homopolymer or copolymer. The polyoxymethylene polymer may have a molecular weight of generally greater than about 2000 Dalton. Cyclic oligomers of formaldehyde such as trioxane can also be used as the formaldehyde source.

In one embodiment, the aliphatic alcohol and the formaldehyde source are combined together in the presence of a solvent to form a reaction mixture such as a liquid reaction mixture. The reaction mixture can then be contacted with a catalyst for producing the formal. The solvent may comprise any suitable solvent capable of solving or depolymerizing the formaldehyde source. The solvent should also not adversely interfere with the reaction that forms the formal. In one embodiment, a solvent is selected that is also an entrainer for water produced during the reaction. In particular, the solvent may form an azeotrope with water. The solvent, for instance, can have a boiling point of less than about 150° C. at atmospheric pressure.

Examples of suitable solvents that may be used according to the present disclosure include toluene, cyclohexane, benzene, and chlorinated hydrocarbons. Other examples of solvents in addition to toluene include tetrachloromethane, trichloromethane, dichloromethane, ethylene dichloride, 1,1,2-trichloroethane, 1,1,2-trichlorotrifluoroethane, tertachloroethylene, isopropylcholoride, propylchloride, butylchloride, and the like.

In the reaction mixture, formaldehyde can be present in relation to the long-chain alcohol in generally stoichiometric amounts. In one embodiment, the alcohol may be present in excess amounts in relation to the stoichiometric ratio. On a weight basis, the ratio of formaldehyde to the alcohol can be from about 1:2 to about 4:1, such as from about 1.2:2 to about 2:1. The actual weight ratio between the reactants will depend upon the formaldehyde source used and the hydrocarbon chain length of the alcohol and whether the alcohol is a glycol or an aliphatic alcohol.

The solvent is present in the reaction mixture generally in an amount sufficient to dissolve the formaldehyde source and possibly the alcohol. In general, the weight ratio between the solvent and the alcohol can be from about 0.5:1 to about 2:1.

The reaction mixture of the present disclosure containing the aliphatic alcohol, the formaldehyde source and the solvent can be premixed prior to contact with the catalyst or can be combined while contacting a catalyst simultaneously. The catalyst is typically an acidic species capable of initiating a reaction between the formaldehyde source and the aliphatic alcohol. Although a homogenous catalyst may be used in some applications, in one embodiment, a heterogeneous catalyst is used. The catalyst, for instance, can be immiscible in the reaction mixture. In one embodiment, the catalyst comprises a solid catalyst. As used herein, a solid catalyst is a catalyst that includes one solid component. For instance, a catalyst may comprise an acid that is adsorbed or otherwise fixed to a solid support. The catalyst may also be in a liquid phase that is not miscible or at least partially immiscible with the reaction mixture.

Various advantages and benefits are obtained when using a heterogeneous catalyst. For example, when using a heterogeneous catalyst, the catalyst can be easily separated from the reaction mixture, the formaldehyde source, or the formal that is produced. In one embodiment, a solid catalyst may be used that remains in the reactor that is used to produce the formal. In this manner, the catalyst can be used over and over again. Solid catalysts also tend to be less corrosive.

The catalyst can be selected from the group consisting of trifluoromethanesulfonic acid, perchloric acid, methanesulfonic acid, toluenesulfonic acid and sulfuric acid, or derivatives thereof such as anhydrides or esters or any other derivatives that generate the corresponding acid under the reaction conditions. Lewis acids like boron trifluoride, arsenic pentafluoride can also be used. It is also possible to use mixtures of all the individual catalysts mentioned above.

In one embodiment, the heterogeneous catalyst may comprise a Lewis or Broensted acid species dissolved in an inorganic molten salt. The molten salt may have a melting point below 200° C., such as less than about 100° C., such as less than about 30° C. The molten salt can then be immobilized or fixed onto a solid support as described above. The solid support, for instance, may be a polymer or a solid oxide. An example of an organic molten salt include ionic liquids. For instance, the ionic liquid may comprise 1-n-alkyl-3-methylimidazolium triflate. Another example is 1-n-alkyl-3-methylimidazolium chloride.

In one embodiment, the acidic compound present in the catalyst can have a pKa below 0, such as below about −1, such as below about −2, when measured in water at a temperature of 18° C. The pKa number expresses the strength of an acid and is related to the dissociation constant for the acid in an aqueous solution.

Examples of heterogeneous catalysts that may be used according to the present disclosure include the following:

(1) solid catalysts represented by acidic metal oxide combinations which can be supported onto usual carrier materials such as silica, carbon, silica-alumina combinations or alumina. These metal oxide combinations can be used as such or with inorganic or organic acid doping. Suitable examples of this class of catalysts are amorphous silica-alumina, acid clays, such as smectites, inorganic or organic acid treated clays, pillared clays, zeolites, usually in their protonic form, and metal oxides such as ZrO2-TiO2 in about 1:1 molar combination and sulfated metal oxides e.g. sulfated ZrO2. Other suitable examples of metal oxide combinations, expressed in molar ratios, are: TiO2-SiO2 1:1 ratio; and ZrO2-SiO2 1:1 ratio.

(2) several types of cation exchange resins can be used as acid catalyst to carry out the reaction. Most commonly, such resins comprise copolymers of styrene, ethylvinyl benzene and divinyl benzene functionalized so as to graft SO3H groups onto the aromatic groups. These acidic resins can be used in different physical configurations such as in gel form, in a macro-reticulated configuration or supported onto a carrier material such as silica or carbon or carbon nanotubes. Other types of resins include perfluorinated resins carrying carboxylic or sulfonic acid groups or both carboxylic and sulfonic acid groups. Known examples of such resins are: NAFION, and AMBERLYST resins. The fluorinated resins can be used as such or supported onto an inert material like silica or carbon or carbon nanotubes entrapped in a highly dispersed network of metal oxides and/or silica.

(3) heterogeneous solids, having usually a lone pair of electrons, like silica, silica-alumina combinations, alumina, zeolites, silica, activated charcoal, sand and/or silica gel can be used as support for a Broensted acid catalyst, like methane sulfonic acid or para-toluene sulfonic acid, or for a compound having a Lewis acid site, such as SbF5, to thus interact and yield strong Broensted acidity. Heterogeneous solids, like zeolites, silica, or mesoporous silica or polymers like e.g. polysiloxanes can be functionalized by chemical grafting with a Broensted acid group or a precursor therefore to thus yield acidic groups like sulfonic and/or carboxylic acids or precursors therefore. The functionalization can be introduced in various ways known in the art like: direct grafting on the solid by e.g. reaction of the SiOH groups of the silica with chlorosulfonic acid; or can be attached to the solid by means of organic spacers which can be e.g. a perfluoro alkyl silane derivative. Broensted acid functionalized silica can also be prepared via a sol gel process, leading to e.g. a thiol functionalized silica, by co-condensation of Si(OR)4 and e.g. 3-mercaptopropyl-tri-methoxy silane using either neutral or ionic templating methods with subsequent oxidation of the thiol to the corresponding sulfonic acid by e.g. H2O2. The functionalized solids can be used as is, i.e. in powder form, in the form of a zeolitic membrane, or in many other ways like in admixture with other polymers in membranes or in the form of solid extrudates or in a coating of e.g. a structural inorganic support e.g. monoliths of cordierite; and

(4) heterogeneous heteropolyacids having most commonly the formula HxPMyOz. In this formula, P stands for a central atom, typically silicon or phosphorus. Peripheral atoms surround the central atom generally in a symmetrical manner. The most common peripheral elements, M, are usually Mo or W although V, Nb, and Ta are also suitable for that purpose. The indices xyz quantify, in a known manner, the atomic proportions in the molecule and can be determined routinely. These polyacids are found, as is well known, in many crystal forms but the most common crystal form for the heterogeneous species is called the Keggin structure. Such heteropolyacids exhibit high thermal stability and are non-corrosive. The heterogeneous heteropolyacids are preferably used on supports selected from silica gel, kieselguhr, carbon, carbon nanotubes and ion-exchange resins. A preferred heterogeneous heteropolyacid herein can be represented by the formula H3PM12O40 wherein M stands for W and/or Mo. Examples of preferred PM moieties can be represented by PW12, PMo12, PW12/SiO2, PW12/carbon and SiW12.

The reaction of the present disclosure can be carried out continuously or in a batch-wise process (discontinuous). The reaction can be completed very quickly yielding extremely high conversion rates. For instance, greater than 80%, such as greater than 90%, such as even greater than 95% of the formaldehyde source may be converted into a formal.

In a further aspect of the invention the reaction can be carried out at a temperature higher than 0° C., preferably ranging from 0° C. to 200° C., more preferably ranging from 20° C. to 150° C., further preferably ranging from 40° C. to 130° C. and most preferably from 50° C. to 115° C., especially from 80° C. to 120° C. or from 80° C. to 100° C.

In one particular embodiment, the long-chain alcohol is dissolved with a formaldehyde source, such as paraformaldehyde, in a solvent, such as toluene. The resulting reaction mixture is then contacted with a catalyst, particularly a solid catalyst while being heated and under reflux. The formed water can be distilled off and collected in a water separator, such as a Dean-Stark apparatus. The reaction can continue until no further water is formed. The resulting product can be filtered to remove the catalyst to yield a final product. In one embodiment, the resulting product can be cooled in order to cause the Bis-formal to precipitate. The resulting solid product can then be easily separated from any remaining liquids such as through filtration. In one embodiment, the Bis-formal can be recrystallized for improving purity. Recrystallization can occur by dissolving the Bis-formal in the above solvent or a similar solvent.

When producing a Bis-alkyformal, the molecular weight of the resulting Bis-alkylformal can vary depending upon the alcohol used to form the product. In general, the molecular weight of the Bis-alkylformal is greater than about 250, such as greater than about 350, such as greater than about 500 g/mole. In other embodiments, the molecular weight can be greater than about 600, such as greater than about 700, such as greater than about 800, such as greater than about 1000 g/mole. In general, the molecular weight is less than about 10,000, such as less than about 5,000 g/mole.

As described above, the Bis-alkylformal may be used as a chain transfer agent during formation of the polyoxymethylene polymer. The amount of chain transfer agent added during the polymerization process can vary depending upon the particular application. For instance, the above described Bis-alkylformal can be added in an amount greater than about 2% by weight, such as greater than about 5% by weight, such as greater than about 7.5% by weight, such as greater than about 10% by weight, such as greater than about 12% by weight, based on the monomer (mixture). In general, the Bis-alkylformal is present in an amount less than about 40% by weight based on the monomer mixture.

Of particular advantage, by incorporating the Bis-alkylformal into the polyoxymethylene polymer as described above, significant amounts of the formal are reacted with the polymer. For instance, greater than 80% of the polymer produced can include long-chain alkyl end groups. More particularly greater than 85%, such as greater than 90% such as even greater than 95% of the polymer may include the relatively long-chain alkyl end groups. For instance, in one embodiment, the alkyl end groups are present in the resulting polymer in an amount greater than about 0.005 mol/polymer kg, such as greater than about 0.01 mol/polymer kg.

It is believed that greater amounts of alkyl end groups can be incorporated into the polymer if the Bis-alkylformal is dissolved in one of the monomers during polymerization. For instance, in one embodiment, the temperature and/or the pressure of the system are increased an amount sufficient for the Bis-alkylformal to dissolve in the primary monomer, particularly trioxane.

In order to terminate the polymerization, the homogeneous, liquid reaction mixture, which still comprises unconverted monomers, such as trioxane and formaldehyde, alongside polymer, is brought into contact with deactivators. These can be added in bulk form or a form diluted with an inert aprotic solvent to the polymerization mixture. The result is rapid and complete deactivation of the active chain ends.

Deactivators that can be used are those compounds which react with the active chain ends in such a way as to terminate the polymerization reaction. Examples are the organic bases triethylamine or melamine, and also the inorganic bases potassium carbonate or sodium acetate. It is also possible to use very weak organic bases, such as carboxamides, e.g. dimethylformamide. Tertiary bases are particularly preferred, examples being triethylamine and hexamethylmelamine.

The concentrations used of the bases are from 1 ppm to 1% by weight, based on the polymerization material. Concentrations of from 10 ppm to 5000 ppm are preferred.

Typical deactivation temperatures vary in the range from 125° C. to 180° C., particularly preferably in the range from 135° C. to 160° C., and very particularly preferably in the range from 140° C. to 150° C.

Typical deactivation pressures vary in the range from 3 to 100 bar, preferably from 5 to 40 bar.

The polymerization can take place in the reactors known for the preparation of POM homo- and copolymers. Typically, kneaders or extruders are used, designed to be temperature-controllable and pressure-resistant.

The phases i) and ii) are particularly preferably carried out in an assembly where a continuous transition is present between the polymerization in a heterogeneous phase and the polymerization in a substantially homogeneous phase. However, the two steps of the process can also be undertaken in different assemblies.

The deactivation of the polymerization mixture can be undertaken in a kneader or extruder, or else in a tubular reactor using static mixers.

The polymerization time can vary within a wide range and typically varies in the range from 10 seconds to 10 minutes, preferably from 15 seconds to 5 minutes, and particularly preferably from 20 to 100 seconds.

The deactivation proceeds very rapidly and is practically terminated with the mixing of the components. After the deactivation of the active chain ends, there is then no further need for capping of end groups to obtain heat-resistant polymers.

After the deactivation of the POM, it can be brought to an elevated temperature to remove unstable end groups (thermal hydrolysis), for a certain time. The liquid polymerization mixture can then be transferred into a depressurization zone, and residual monomers and solvent can be removed via application of a reduced pressure. This removal can also take place in a plurality of stages at different pressures.

The depressurization zone is formed by a space which is filled by the hot polymer solution or hot polymer melt. Application of a subatmospheric pressure, preferably of a pressure of less than 500 mbar, in particular of less than 200 mbar, drives off most of the remaining residual monomer and residual solvent from the polymer solution, utilizing the temperature of the latter. This step of the process can be carried out in a separate portion of the tubular reactor, preferably in an extruder. However, it is also possible to use other assemblies, e.g. a flash chamber. In the case of polymer solutions under pressure, these are first depressurized to ambient pressure in the depressurization zone, before the residual monomers are removed by suction.

For this, it is preferable that, after step iii), and with maintenance of the pressure, the polymer solution is transferred into an extruder in which the depressurization and the removal by suction of the monomer residues and solvent residues takes place.

It is particularly preferable to use a twin-screw extruder.

Stabilizers and processing aids (hereinafter also termed “additives”) can, if appropriate, be incorporated into the POM polymer in the depressurization zone.

In one preferred variant of the inventive process, after the removal of the monomer residues and solvent residues, a mixture of additives is fed into the extruder and incorporated into the hot polyoxymethylene polymer.

Components that can be used in the mixture of additives are the compounds usually used for the stabilization and/or modification of oxymethylene polymers.

Examples of these are antioxidants, acid scavengers, formaldehyde scavengers, UV stabilizers, or heat stabilizers. The mixture of additives can comprise, alongside these, processing aids, such as adhesion promoters, lubricants, nucleating agents, mold-release agents, fillers, reinforcing materials, or antistatic agents, and also additives which give the molding composition a desired property, examples being dyes and/or pigments, and/or impact modifiers, and/or additives conferring electrical conductivity, and also mixtures of the said additives, but without any restriction of scope to the examples mentioned.

Once the monomer residues and solvent residues have been driven off in the depressurization zone, the polymer melt is solidified. This can take place during or immediately after discharge from the depressurization zone. The solidified polymer, if appropriate comprising additives, is then pelletized in a manner known per se.

An extraction stage can be used to remove remaining residual monomers and/or oligomers and/or solvents and/or other contaminants from the polymer.

Pelletization and extraction can take place in assemblies known per se.

The extraction stage is preferably followed by a drying process, in order to free the pellets from residues of adherent extractant.

In the polymerization process described above, the polyoxymethylene polymer is generally formed in a two-phase process. Alternatively, the polyoxymethylene polymer can be produced in a single homogeneous phase. For example, EP 0638357 and Canadian Patent No. 2,130,029, which are incorporated herein by reference, both describe a continuous homogeneous polymerization of trioxane to produce a polyoxymethylene polymer. The continuous homogenous polymerization occurs at temperatures greater than about 135° C., such as temperatures greater than 145° C., such as at temperatures from about 135° C. to about 165° C.

In one embodiment, the continuous preparation of polyoxymethylene polymers in a homogenous phase occurs in a flow tube equipped with mixing elements, such as static mixing elements. For instance, the monomers including the formal of the present disclosure can be fed to a reactor that includes a mixing zone, a polymerization zone, a deactivation zone, and a stabilization zone. In the mixing zone, the monomers, formal and initiator are mixed. In the polymerization zone, polymerization takes place. In the stabilization zone, hydrolytic degradation of the unstable chain ends of the polyoxymethylene polymer can occur. The individual process zones can be continuous. The pressure in the reactor can be greater than about 15 bar, such as greater than about 20 bar, such as greater than about 25 bar. The polymer leaving the reactor can be free from residual monomers through a degassing operation, such as in a flash chamber.

Conducting polymerization in a single homogenous phase may provide advantages in some applications. For instance, greater amounts of the formal may be added to the process and dissolved in the other monomers, such as trioxane.

The formed polyoxymethylene polymer can be remelted, provided with additives, and repelletized.

Once formed, the polyoxymethylene polymer can be remelted, provided with additives, and repelletized.

After the polyoxymethylene polymer containing the long-chain alkyl end groups is produced, in one embodiment, the polymer may be used as an additive, such as a flow additive. In one embodiment, the flow additive may be combined with a thermoplastic polymer in order to improve the tribological properties of the resulting composition.

The polyoxymethylene additive of the present disclosure can be combined with any suitable thermoplastic polymer. The thermoplastic polymer may be present in the polymer composition in an amount sufficient to form a primary matrix when the composition is molded into a product. In one embodiment, the thermoplastic polymer may be present in the polymer composition in an amount greater than about 40% by weight, such as in an amount greater than about 50% by weight, such as in an amount greater than about 60% by weight, such as in an amount greater than about 70% by weight, such as in an amount greater than about 80% by weight. The polyoxymethylene additive of the present disclosure, on the other hand, can be present in the polymer composition in an amount from about 1% to about 80% by weight. For instance, the polyoxymethylene additive can be present in an amount greater than about 5% by weight, such as in an amount greater than about 10% by weight. The polyoxymethylene additive can be combined with the thermoplastic polymer during melt processing. Alternatively, the polyoxymethylene additive can be compounded with the thermoplastic polymer to form a master batch. The master batch can then be combined with further amounts of the thermoplastic polymer and any other additives.

For example, in one embodiment, a formaldehyde scavenger may be combined with the polymer. A formaldehyde scavenger is a compound that reacts and binds formaldehyde.

In general, the total amount of formaldehyde scavengers present in the composition is relatively small. For instance, the formaldehyde scavengers can be present in an amount less than about 2 percent by weight, such as from about 0.01 percent to about 2 percent by weight, such as from about 0.05 percent to about 0.5 percent by weight (which excludes other nitrogen containing compounds that may be present in the composition that are not considered formaldehyde scavengers such as waxes or hindered amines). Any suitable formaldehyde scavenger can be included into the composition including, for example, aminotriazine compounds, allantoin, hydrazides, polyamides, melamines, or mixtures thereof. In one embodiment, the nitrogen containing compound may comprise a heterocyclic compound having at least one nitrogen atom adjacent to an amino substituted carbon atom or a carbonyl group. In one specific embodiment, for instance, the nitrogen containing compound may comprise benzoguanamine.

In still other embodiments, the nitrogen containing compound may comprise a melamine modified phenol, a polyphenol, an amino acid, a nitrogen containing phosphorus compound, an acetoacetamide compound, a pyrazole compound, a triazole compound, a hemiacetal compound, other guanamines, a hydantoin, a urea including urea derivatives, and the like.

The nitrogen containing compound may comprise a low molecular weight compound or a high molecular weight compound. The nitrogen-containing compound having a low molecular weight may include, for example, an aliphatic amine (e.g., monoethanolamine, diethanolamine, and tris-(hydroxymethyl)aminomethane), an aromatic amine (e.g., an aromatic secondary or tertiary amine such as o-toluidine, p-toluidine, p-phenylenediamine, o-aminobenzoic acid, p-aminobenzoic acid, ethyl o-aminobenzoate, or ethyl p-aminobenzoate), an imide compound (e.g., phthalimide, trimellitimide, and pyromellitimide), a triazole compound (e.g., benzotriazole), a tetrazole compound (e.g., an amine salt of 5,5′-bitetrazole, or a metal salt thereof), an amide compound (e.g., a polycarboxylic acid amide such as malonamide or isophthaldiamide, and p-aminobenzamide), hydrazine or a derivative thereof [e.g., an aliphatic carboxylic acid hydrazide such as hydrazine, hydrazone, a carboxylic acid hydrazide (stearic hydrazide, 12-hydroxystearic hydrazide, adipic dihydrazide, sebacic dihydrazide, or dodecane diacid dihydrazide; and an aromatic carboxylic acid hydrazide such as benzoic hydrazide, naphthoic hydrazide, isophthalic dihydrazide, terephthalic dihydrazide, naphthalenedicarboxylic dihydrazide, or benzenetricarboxylic trihydrazide)], a polyaminotriazine [e.g., guanamine or a derivative thereof, such as guanamine, acetoguanamine, benzoguanamine, succinoguanamine, adipoguanamine, 1,3,6-tris(3,5-diamino-2,4,6-triazinyl)hexane, phthaloguanamine or CTU-guanamine, melamine or a derivative thereof (e.g., melamine, and a condensate of melamine, such as melam, melem or melon)], a salt of a polyaminotriazine compound containing melamine and a melamine derivative with an organic acid [for example, a salt with (iso)cyanuric acid (e.g., melamine cyanurate)], a salt of a polyaminotriazine compound containing melamine and a melamine derivative with an inorganic acid [e.g., a salt with boric acid such as melamine borate, and a salt with phosphoric acid such as melamine phosphate], uracil or a derivative thereof (e.g., uracil, and uridine), cytosine and a derivative thereof (e.g., cytosine, and cytidine), guanidine or a derivative thereof (e.g., a non-cyclic guanidine such as guanidine or cyanoguanidine; and a cyclic guanidine such as creatinine), urea or a derivative thereof [e.g., biuret, biurea, ethylene urea, propylene urea, acetylene urea, a derivative of acetylene urea (e.g., an alkyl-substituted compound, an aryl-substituted compound, an aralkyl-substituted compound, an acyl-substituted compound, a hydroxymethyl-substituted compound, and an alkoxymethyl-substituted compound), isobutylidene diurea, crotylidene diurea, a condensate of urea with formaldehyde, hydantoin, a substituted hydantoin derivative (for example, a mono or diC₁₋₄alkyl-substituted compound such as 1-methylhydantoin, 5-propylhydantoin or 5,5-dimethyihydantoin; an aryl-substituted compound such as 5-phenyihydantoin or 5,5-diphenylhydantoin; and an alkylaryl-substituted compound such as 5-methyl-5-phenylhydantoin), allantoin, a substituted allantoin derivative (e.g., a mono, di or triC₁₋₄alkyl-substituted compound, and an aryl-substituted compound), a metal salt of allantoin (e.g., a salt of allantoin with a metal element of the Group 3B of the Periodic Table of Elements, such as allantoin dihydroxyaluminum, allantoin monohydroxyaluminum or allantoin aluminum), a reaction product of allantoin with an aldehyde compound (e.g., an adduct of allantoin and formaldehyde), a compound of allantoin with an imidazole compound (e.g., allantoin sodium dl-pyrrolidonecarboxylate), an organic acid salt].

The composition may also contain colorants, light stabilizers, antioxidants, heat stabilizers, processing aids, and fillers.

Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

In one embodiment, the composition may contain a nucleant. The nucleant, for instance, may increase crystallinity and may comprise an oxymethylene terpolymer. In one particular embodiment, for instance, the nucleant may comprise a terpolymer of butanediol diglycidyl ether, ethylene oxide or dioxolane, and trioxane. The nucleant can be present in the composition in an amount greater than about 0.05% by weight, such as greater than about 0.1% by weight. The nucleant may also be present in the composition in an amount less than about 2% by weight, such as in an amount less than about 1% by weight.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate](Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate](Irganox 259, BASF), and 3,5-di-tert-butyl-4-hydroxytoluene (Lowinox BHT, Chemtura). Preference is given to Irganox 1010 and especially Irganox 245. The above compounds may be present in the composition in an amount less than about 2% by weight, such as in an amount from about 0.01% to about 1% by weight.

Light stabilizers that may be present in the composition include sterically hindered amines. Such compounds include 2,2,6,6-tetramethyl-4-piperidyl compounds, e.g., bis(2,2,6,6-tetramethyl-4-piperidyl) sebacate (Tinuvin 770, BASF) or the polymer of dimethyl succinate and 1-(2-hydroxyethyl)-4-hydroxy-2,2,6,6-tetramethyl-4-piperidine (Tinuvin 622, BASF). In one embodiment, the light stabilizer may comprise 2-(2H-benzotriazol-2-yl) 4,6-bis(1-ethyl-1-phenyl-ethyl)phenol (Tinuvin 234). Other hindered amine light stabilizers that may be used include oligomeric compounds that are N-methylated. For instance, another example of a hindered amine light stabilizer comprises ADK STAB LA-63 light stabilizer available from Adeka Palmarole.

One or more light stabilizers may be present in the composition in an amount generally less than about 5% by weight, such as in an amount less than 4% by weight, such as in an amount less than about 2% by weight. The light stabilizers, when present, can be included in amounts greater than about 0.1% by weight, such as in amounts greater than about 0.5% by weight.

The above light stabilizers may protect the composition from ultraviolet light. In addition to the above light stabilizers, UV stabilizers or absorbers that may also be present in the composition include benzophenones or benzotriazoles.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm. The composition can further include thermoplastic or thermoset polymeric additives, or elastomers such as polyethylene, polyurethane, polymethyl methacrylate, polybutadiene, polystyrene, or else graft copolymers whose core has been prepared by polymerizing 1,3-butadiene, isoprene, n-butyl acrylate, ethylhexyl acrylate, or mixtures of these, and whose shell has been prepared by polymerizing styrene, acrylonitrile or (meth)acrylates.

Once the composition containing the polyoxymethylene polymer containing the long-chain alkyl end groups is formulated, the composition can be used to mold various different products.

Shaping processes for forming articles of the polyoxymethylene composition can include, without limitation, extrusion, injection molding, blow-molding, compression molding, hot-stamping, pultrusion, and so forth. Shaped articles that may be formed may include structural and non-structural shaped parts. For instance, automotive components such as fuel tanks, and fuel caps, fuel filler necks, fuel sender unit components (e.g. flanges or swirl pot), fuel pumps, fuel rails, turn signal and light shifters, power window components, door lock system components, and so forth can be formed from the polyoxymethylene composition.

The polyoxymethylene composition can be shaped according to an injection molding process to form products that can have a relatively intricate or complicated shape. For example, products that can be formed from the polyoxymethylene composition that may be formed according to an injection molding process can include components such as, without limitation, mechanical gears, sliding and guiding elements, housing parts, springs, chains, screws, nuts, fan wheels, pump parts, valve bodies, hardware such as locks, handles, and hinges, zippers, and so forth.

The polyoxymethylene composition can also be utilized in electrical applications, for instance in forming insulators, bobbins, connectors, and parts for electronic devices such as televisions, telephones, etc. Medical devices such as injection pens and metered dose inhalers can be formed of the polyoxymethylene composition as well as a variety of sporting goods equipment (e.g., paintball accessories and airsoft guns) and household appliances (e.g., coffee makers and knife handles). The polyoxymethylene composition can also be utilized in forming automotive components such as, without limitation, fuel system components (e.g., fuel tanks, fuel sender units, fuel caps, fuel pumps, etc.), lighting and signal components, and window and door lock components.

The present disclosure may be better understood with reference to the following examples.

### Example No. 1

### Reagents

| | | |
|---|---|---|
| Stearyl Alcohol | 980 g | (3.63 mole) |
| Paraformaldehyde | 326 g | (10.86 mole) |
| Toluene | 1.8 | l |
| Amberlyst 15 | 60 | g |
| (strong acidic ion exchange resin) | | |

Reaction Equation (Stoichiometric):

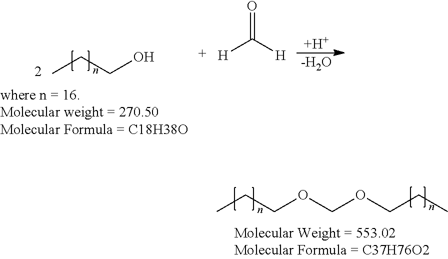

Preparation:

The ion exchange resin was conditioned. In a first step, 60 g of the wet resin was stirred in 50 ml acetone for 10 minutes and subsequently the solvent was decanted. Then the resin was filtered and washed with 30 ml of toluene.

Procedure:

980 g stearyl alcohol were dissolved together with 326 g paraformaldehyde and 60 g ion of exchange resin in 1.8 l of toluene and stirred under reflux. The formed water was collected in a water separator (Dean-Stark apparatus). Since the paraformaldehyde was not dried before usage, the formed water amounts were larger than the theoretical calculated. The reaction was terminated when no further water formation was observed. Then the mixture was filtered to remove the resin and was allowed to cool down to room temperature. The Bis-stearylformal precipitated. To ensure a quantitative precipitation, the system was further cooled in an ice bath. Then the Bis-stearylformal was filtered from the toluene and washed with 50 g cold toluene. White crystals were obtained that were dried at 50° C. and reduced pressure. No further purification was necessary.

The above procedure was also repeated using eicosanyl alcohol and a mixture of alcohols. The mixture of alcohols included a C₁₈ alcohol, a C₂₀ alcohol, a C₂₂ alcohol and a C₂₄ alcohol.

The testing of the produced formals was performed according to the following standards:

Thermal data (melting, onset and crystallization point) was determined with Differential Scanning Calorimetry (DSC, TA Instruments, Q200); heating rate 10K/min. according to ISO 11357-1, -2, -3.

Conversions and purities were determined by NMR using d-HFiP on a Varian 400 MHz-Spectrometer.

Conversions and purities were determined by Infrared Spectroscopy on a Bruker Tensor 27 according DIN 51451.

The following results were obtained:

| Sample | Name of Alkyl- | | Mw | | Melting | Onset | Cp. | Conversion | Purity | | |
|---|---|---|---|---|---|---|---|---|---|---|---|
| # | Formal | Formula | [g/mol] | CAS | Point [° C.] | [° C.] | [° C.] | [%] | [%] | IR | 1H-NMR |
| 1 | Bis- | C25 H52 O2 | 384.68 | 140477-03-8 | 29.17 | 21.59 | 21.49 | 99.3 | >99.0 | yes | yes |
| | Dodecanylformal | | | | | | | | | | |
| 2 | Bis- | C37H76O2 | 553.02 | 41344-25-6 | 58.09 | 48.44 | 47.09 | 99.6 | >99.5 | yes | yes |
| | Stearylformal | | | | | | | | | | |
| 3 | Bis- | C41H84O2 | 609.13 | n.a. | 65.17 | 52.41 | 51.34 | >99.5 | >99.5 | yes | yes |
| | Eicosanylformal | | | | | | | | | | |
| 4 | Mixture of | C5H12O2(CH2)n(CH2)n | 654.68 | n.a. | 50.48 | 47.46 | 41.15 | >99.0 | >99.0 | no | yes |
| | Bis-alkylformals | n = 18 (44.1%) | | | | | | | | | |
| | | n = 20 (12.0%) | | | | | | | | | |
| | | n = 22 (43.5%) | | | | | | | | | |
| | | n = 24 (0.3%) | | | | | | | | | |

### Example No. 2

The following example demonstrates some of the advantages and benefits of the present disclosure.

Reagents:

| | | |
|---|---|---|
| Poly(ethylene glycol) methyl ether | 150 g | (0.2 mole) |
| (mPEG₇₅₀, average Mₙ 750 g/mole) | | |
| Paraformaldehyde | 5.83 g | (0.2 mole) |
| Toluene | 200 | ml |
| Amberlyst 15 | 10 | g |
| (strong acidic ion exchange resin) | | |

Reaction Equation:

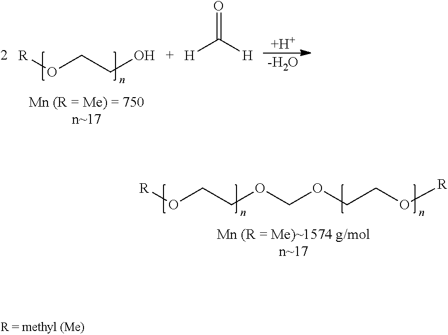

In this embodiment, n is approximately 17. The molecular weight of the resulting formal is approximately 1,574 g/mole.

Preparation:

The ion exchange resin was conditioned. In a first step, 10 g of the wet resin were stirred in 20 ml acetone for 10 minutes and subsequently the solvent was decanted. Then the resin was filtered and washed with 20 ml toluene. The resin was not allowed to dry.

Procedure:

150 g mPEG₇₅₀ were dissolved together with 5.83 g paraformaldehyde and 10 g of ion exchange resin in 200 ml of toluene and stirred under reflux. The formed water was collected in a water separator (Dean-Stark apparatus). Since the paraformaldehyde is not dried before usage, the formed water amounts are larger than the theoretical calculated. The reaction is terminated when no further water formation was observed. Then the mixture was filtered to remove the resin and subsequently the toluene was distilled yielding a waxy product.

### Example No. 3

Polymerization trials were performed as described in patent U.S. Pat. No. 8,354,495 B2 (Process for the preparation of oxymethylene polymers and apparatus suitable for this purpose). The polymerization of trioxane, dioxolane and the bis-alkyl formal e.g. bis-stearylformal (synthesized as described in patent 2012P0278) was started with an initiator for cationic polymerizations in a gas-tight kneader or extruder. The temperature started at 100° C. with a gradient to 160° C. Typical polymerization times were between 40 and 60 seconds. The homogeneous polymer phase was stabilized by addition of a deactivator e.g. an amine. In the next step volatile components were removed in a degassing extruder. Finally the polymer was strand granulated and dried in an air circulating oven at 100° C. Conversions ≧280% were achieved.

The testing of the produced polymers was performed according to the following standards:

### MVR (190° C., 2.16 kg): ISO 1133

Drying losses were determined by weighing the samples before and after drying NMR measurements were performed in d-HFiP on a Varian 400 MHz-Spectrometer GPC measurements were done on a SunChrom Sun Flow 100 device using hexafluoroisopropanol as eluent and two PSS-PFG columns (8×300 mm, 100 Å+1000 Å), detector Agilent 1200 RI-detector.

The following results were obtained:

| | | Bis- | | MVR | | | | | | |
|---|---|---|---|---|---|---|---|---|---|---|
| | | Stearyl- | Drying | (190° C., | | | | | | |
| Sam- | Dioxolan | formal | Losses | 2.16 kg) | TO | DO | Stearyl | M_{w} | Mₙ | |
| ple | [w.-%] | [w.-%] | [w.-%] | [cm³/10 min] | [w %] | [w %] | [w %] | [g/mol] | [g/mol] | PD |
| 1 | 3.4 | 1.0 | 1.72 ± 0.35 | 28.91 ± 1.96 | 96.14 ± 0.13 | 2.85 ± 0.09 | 1.07 ± 0.05 | 75059 ± 4220 | 25412 ± 684 | 3 ± 0.26 |
| 2 | 3.4 | 1.8 | 3.25 ± 0.042 | 50.65 ± 1.91 | 95.50 ± 0.25 | 2.77 ± 0.09 | 1.62 ± 0.16 | 92394 ± 3353 | 21015 ± 894 | 2.8 ± 0.27 |
| 3 | 3.4 | 1.8 | 1.67 ± 0.21 | 60.45 ± 1.63 | 95.88 ± 0.04 | 2.38 ± 0.01 | 1.74 ± 0.03 | 64506 ± 900 | 18079 ± 988 | 4 ± 0.18 |

### Example No. 4

Various polyoxymethylene polymer additives were made in accordance with the present disclosure. In particular, polyoxymethylene copolymers were produced using Bis-stearylformal as a chain transfer agent. The amount of Bis-stearylformal added during polymerization was varied. In particular, polyoxymethylene copolymers were produced in which Bis-stearylformal was added at 5 wt. %, 7.5 wt. %, and 10 wt. % based upon the weight of the monomers

The resulting polyoxymethylene polymer additive was then combined with a conventional polyoxymethylene copolymer in amounts of either 5% by weight or 10% by weight. The conventional polyoxymethylene copolymer combined with the additive had a melt volume flow rate of 2.67 g/10 min. when tested at 190° C. and at a load of 2.16 kg.

The following is a standard procedure for producing the polyoxymethylene additive containing long-chain alkyl end groups.

The polymerization trials were performed in a Teflon beaker that was placed in a two-necked flask containing a planar base. The glass apparatus was fitted with a septum and a pressure control valve. 1 mol Trioxan was copolymerized at 85° C. with 3.4 w.-% Dioxolan and 5 w.-% of Bis-Stearylformal (BSF). The polymerization was initiated with 1.6 ppm of moderated Trifluormethane sulfonic acid (clouding point at 13 seconds) and finished after 5 minutes. The obtained raw material was grinded and hydrolyzed at 170° C. in 1 liter of n-Methyl-2-pyrrolidon (NMP) to which has been added 1 ml of Triethylamine (TEA). After one hour, the system was allowed to cool down to room temperature again whereat the polymer having alkyl end groups precipitates. Afterwards, the product was filtered and washed three times each with 50 ml of methanol and finally dried at 60° C. and nitrogen atmosphere. The conversion was 86.6% and the quantity of stearyl end groups was determined to 85% (4.25 w.-%).

In the procedure above, Bis-stearylformal was added in an amount of 5 wt. % based on the monomer mixture. As described above, in other embodiments, the Bis-stearylformal was added at 7.5 wt. % and at 10 wt. %.

The polyoxymethylene additive containing the long-chain alkyl end groups was then combined with a commercially available polyoxymethylene copolymer and the following examples were produced:

TABLE NO. 1

| | Amount of Bis- | | Amount of additive |
|---|---|---|---|
| | stearylformal | | combined with |
| Sample | added to trioxane | M_{w} | polyoxymethylene |
| No. | monomer (wt. %) | [g/mol] | copolymer (wt. %) |
| 1 | 5.0 | 33,894 | 5 |
| 2 | | | 10 |
| 3 | 7.5 * | 12,724 | 5 |
| 4 | 10 | 11,231 | 5 |
| 5 | | | 10 |

* not enough material

After the above polymer compositions were formulated, the compositions were tested for melt volume flow rate and various physical properties. The following results were obtained:

| | | Test | | Sample | Sample | Sample | Sample | Sample |
|---|---|---|---|---|---|---|---|---|
| Properties | Unit | method | Control | No. 1 | No. 2 | No. 3 | No. 4 | No. 5 |
| MVR 190/2.16 | ml/10 min | ISO 1133 | 2.67 | 2.73 | 3.16 | 3.27 | 3.71 | 4.37 |
| Tensile Modulus | MPa | ISO 527 | 2,990 | 2,994 | 2,925 | 2,888 | 2,999 | 2,950 |
| Tensile Yield Stress | MPa | ISO 527 | 67.36 | 68.26 | 66.52 | 64.48 | 68.16 | 66.49 |
| Tensile Stress at break | MPa | ISO 527 | 60.41 | 60.92 | 59.36 | 57.24 | 59.80 | 58.05 |
| Elongation at Yield | % | ISO 527 | 11.14 | 11.42 | 11.22 | 11.56 | 10.72 | 10.76 |
| Nominal Elongation at | % | ISO 527 | 26.19 | 27.73 | 28.18 | 29.68 | 29.59 | 29.20 |
| Break | | | | | | | | |
| Notched Impact Strength | kJ/m² | ISO 179-1/ | 8.6 | 8.9 | 9.0 | 9.3 | 8.7 | 8.9 |
| (Charpy, 23° C.) | | 1eA | | | | | | |

As shown above, the additive of the present disclosure can dramatically increase the melt volume flow rate of a polyoxymethylene polymer. For instance, in Sample No. 2 above, the melt volume flow rate was increased by greater than 15%. In Sample No. 3 above, the melt volume flow rate was increased by greater than 20%. In Sample No. 4, the melt volume flow rate was increased by more than 35%. In Sample No. 5, the melt volume flow rate was increased by more than 60%. In Sample No. 5, 10% by weight of the additive was combined with the polyoxymethylene copolymer. The polymer additive was made using 10% by weight of the Bis-stearylformal.

As also shown above, even when adding the additive in amounts of 10% by weight, the physical properties of the polyoxymethylene copolymer are not adversely affected.

The tensile modulus, the tensile yield stress, the elongation at break, and the notched impact strength did not substantially change.

### Example No. 5

The polymerization trials were performed in a Teflon beaker that was placed in a two-necked flask containing a planar base. The glass apparatus was fitted with a septum and a pressure control valve. 1 mol Trioxan was copolymerized at 85° C. with 3.4 w.-% Dioxolan and 5 w.-% of Bis-Stearylformal (BSF). The polymerization was initiated with an initiator for cationic polymerizations and finished after 5 minutes. The obtained raw material was grinded and hydrolyzed at 170=C in 1 liter of n-Methyl-2-pyrrolidon (NMP) to which has been added 1 ml of Triethylamine (TEA). After one hour the system was allowed to cool down to room temperature again whereat the POM-BSF precipitates. Afterwards the product was filtered and washed three times each with 50 ml of methanol and finally dried at 60° C. and nitrogen atmosphere. The conversion was 86.6% and the quantity of incorporated stearyl end groups was determined to 85% (4.25 w.-%).

The testing of the produced polymers was performed according to the following standards:

### MVR (190° C., 2.16 kg): ISO 1133.

Incorporation rates were determined by NMR measurements in d-HFiP on a Varian 400 MHz-Spectrometer.
Thermal data (melting point, onset and crystallization point) have been determined with Differential Scanning Calorimetry (DSC, TA Instruments, Q200); heating rate 10K/min. according to ISO 11357-1, -2, -3.
GPC measurements were done on a SunChrom Sun Flow 100 device using hexafluoroisopropanol as eluent and two PSS-PFG columns (8×300 mm, 100 Å+1000 Å), detector Agilent 1200 RI-detector.

The following polyoxymethylene polymers were produced containing stearyl end groups:

| | | | | | MVR | Incorpo- |
|---|---|---|---|---|---|---|
| | | | | Conver- | (190° C., | rated |
| Sample | TO | DO | BSF | sion | 2.16 kg) | Stearyl |
| No. | [w. %] | [w. %] | [w. %] | [%] | [cm³/10 min] | [w. %] |
| 1 | 91.60 | 3.40 | 5.0 | 86.6 | 878 | 4.25 |
| 2 | 89.06 | 3.45 | 7.49 | 72.4 | n.m. | 7.12 |
| 3 | 86.56 | 3.43 | 10.01 | 76.4 | n.m. | 9.61 |

| Sample | M_{w} | Mₙ | | Melting | Enthalpie 2. | Crystallinity | Onset | Crystallization |
|---|---|---|---|---|---|---|---|---|
| No. | [g/mol] | [g/mol] | PD | Point [° C.] | Heating [J/g] | [%] | [° C.] | Point [° C.] |
| 1 | 33894 | 9395 | 3.6 | 163.9 | 173.50 | 53.22 | 146.4 | 148.25 |
| 2 | 12724 | 5216 | 2.4 | 159.0 | 180.50 | 55.37 | 147.3 | 145.19 |
| 3 | 11231 | 4812 | 2.3 | 159.1 | 168.90 | 51.81 | 146.7 | 144.28 |

The above polymers having stearyl end groups were then combined as an additive with other polyoxymethylene polymers. The additive in the polyoxymethylene polymers were compounded on a DSM Micro 15 compounder at a temperature from 190° C. to 210° C. After the polymers were compounded, the resulting polymer composition was subjected to the following tests:

Tensile bars were produced on a DSM Micro 10 cc device.
Tensile Modulus, Tensile Yield Stress, Tensile Stress at Break, Elongation at Yield, Elongation at Break were determined according to ISO 527.
Charpy Notched Impact Strengths were measured at 23° C. according to ISO 179-1/1eA (CNI).
Stick-slip tests were conducted on a Ziegler Instruments device according VDA 230-206. A ball-on-plate configuration was utilized with a load of 5-30 N, sliding speed of 1-8 mm/s. The ball consists of C9021.
A Block-on-shaft test was used to determine the wear of the corresponding POM sample vs. steel. Test specifications are:
Material shaft: Steel
Shaft diameter: 65 mm

### Roughness Rz: 0.8 μm

### Load F_{N}: 3.1 N

Sliding velocity: 136 m/min
Test duration: 60 h
Stroke: appr. 490 km

In a first set of tests, the polyoxymethylene polymer additives produced above containing stearyl endgroups were combined with a polyoxymethylene polymer having a melt volume flow rate of about 2.67 ml/10 min. The polyoxymethylene polymer was combined with the additive in amounts of 5% by weight or 10% by weight. The following results were obtained:

TABLE 2

| | |
|---|---|
| Sample 1 | POM-Stearyl with 4.25 w.-% Stearyl End Groups |
| Sample 2 | POM-Stearyl with 7.12 w.-% Stearyl End Groups |
| Sample 3 | POM-Stearyl with 9.61 w.-% Stearyl End Groups |

| | | Polyoxymethylene | 5 w.-% | +5 w.-% | +5 w.-% | +10 w.-% | +10 w.-% |
|---|---|---|---|---|---|---|---|
| Properties | Unit | Polymer Control | Sample 1 | Sample 2 | Sample 3 | Sample 1 | Sample 3 |
| MVR 190/2.16 kg | ml/10 min | 2.67 | 2.73 | 3.16 | 3.27 | 3.71 | 4.37 |
| Tensile Modulus | MPa | 2,990 | 2,994 | 2,925 | 2,888 | 2,999 | 2,950 |
| Tensile Yield Stress | MPa | 67.4 | 68.3 | 66.5 | 64.5 | 68.2 | 66.5 |
| Tensile Stress at break | MPa | 60.4 | 60.9 | 59.4 | 57.2 | 59.8 | 58.1 |
| Elongation at Yield | % | 11.1 | 11.4 | 11.2 | 11.6 | 10.7 | 10.8 |
| Nominal Elongation at | % | 26.2 | 27.7 | 28.2 | 29.7 | 29.6 | 29.2 |
| Break | | | | | | | |
| Notched Impact Strength | kJ/m² | 8.6 | 8.9 | 9.0 | 9.3 | 8.7 | 8.9 |
| (Charpy, 23° C.) | | | | | | | |
| Melting Point [° C.] | ° C. | 168.8 | 166.9 | 167.2 | 167.0 | 167.0 | 166.6 |
| Enthalpie 2. Heating | J/g | 175.3 | 175.9 | 169.8 | 175.3 | 174.5 | 175.6 |
| Crystallinity | % | 53.8 | 54.0 | 52.1 | 53.8 | 53.5 | 53.9 |
| Crystallization Point | ° C. | 148.7 | 148.6 | 148.5 | 148.6 | 148.7 | 148.8 |
| [° C.] | | | | | | | |
| Area 1. Cooling | J/g | 177.0 | 178.1 | 170.1 | 175.4 | 176.7 | 177.3 |
| Onset [° C.] | ° C. | 149.4 | 149.7 | 149.6 | 149.7 | 149.8 | 149.4 |
| Coefficient of Friction | (F = 30N, | 0.33 | 0.33 | 0.32 | 0.33 | 0.33 | 0.25 |
| (vs. C9021) | v = 8 mm/s | | | | | | |
| | t = 45 min) | | | | | | |
| Static Coefficient of | (F = 30N, | 0.54 | 0.54 | 0.53 | 0.54 | 0.55 | 0.48 |
| Friction (vs. C9021) | v = 8 mm/s | | | | | | |
| | t = 45 min) | | | | | | |
| Wear (Plate vs. C9021) | mm | 2.21 | 2.10 | 2.65 | 2.15 | 2.06 | 1.85 |
| Wear (Ball, C9021) | mm | 2.22 | 2.16 | 2.32 | 2.26 | 2.07 | 1.60 |

Sample 3 of the polyoxymethylene polymer additive containing the stearyl end groups was then combined with a polyoxymethylene polymer having a low melt volume flow rate. The polymer had a melt volume flow rate of 1.65 ml/10 min. The polymer additive was combined with the polyoxymethylene polymer in an amount of 15.61% by weight. The polyoxymethylene polymer used in the following test is considered a high strength polyoxymethylene copolymer. The following results were obtained:

TABLE 3

| | | Polyoxy- | +15.61 |
|---|---|---|---|
| | | methylene | w.-% |
| Properties | Unit | Polymer Control | Sample 3 |
| MVR 190/2.16 kg | ml/10 min | 1.65 | 3.39 |
| Tensile Modulus | MPa | 3253 | 3043 |
| Tensile Yield Stress | MPa | 76.1 | 67.7 |
| Tensile Stress at break | MPa | 74.9 | 67.1 |
| Elongation at Yield | % | 18.9 | 19.3 |
| Nominal Elongation at | % | 29.5 | 33.4 |
| Break | | | |
| Notched Impact Strength | kJ/m² | 11.4 | 10.1 |
| (Charpy, 23° C.) | | | |
| Melting Point [° C.] | ° C. | 176.1 | 174.2 |
| Enthalpie 2. Heating | J/g | 181.5 | 177.4 |
| Crystallinity | % | 55.7 | 54.4 |
| Crystallization Point | ° C. | 152.6 | 151.4 |
| [° C.] | | | |
| Area 1. Cooling | J/g | 183.9 | 178.9 |
| Onset [° C.] | ° C. | 153.6 | 152.2 |
| Coefficient of Friction | (F = 30N, | 0.299 | 0.288 |
| (vs. C9021) | v = 8 mm/s, | | |
| | t = 45 min) | | |
| Static Coefficient of | (F = 30N, v = 8 mm/s, | | 0.464 |
| Friction (vs. C9021) | t = 45 min) | | |
| Wear (Plate vs. C9021) | mm | 1.93 | 1.89 |
| Wear (Ball, C9021) | mm | 1.94 | 1.73 |
| Wear (Plate vs. Steel, | mm | 2.45 | 2.13 |
| after 60 h) | | | |

The same additive above was then combined with a polyoxymethylene copolymer having a melt volume flow rate of 1.99 ml/10 min. The polyoxymethylene polymer used in the following test is considered an injection molding grade with good impact and strength characteristics. The following results were obtained:

TABLE 4

| | | Polyoxymethylene | +10.41 w.-% | +15.81 w.-% | +20.81 w.-% |
|---|---|---|---|---|---|
| Properties | Unit | Polymer Control | Sample 3 | Sample 3 | Sample 3 |
| MVR 190/2.16 kg | ml/10 min | 1.99 | 2.99 | 3.31 | 4.99 |
| Tensile Modulus | MPa | 3268 | 3193 | 3221 | 3224 |
| Tensile Yield Stress | MPa | 71.8 | 68.8 | 68.1 | 65.9 |
| Tensile Stress at break | MPa | 71.4 | 67.6 | 66.3 | 64.5 |
| Elongation at Yield | % | 18.7 | 17.7 | 17.4 | 16.3 |
| Nominal Elongation at | % | 28.6 | 33.5 | 34.6 | 8.7 |
| Break | | | | | |
| Notched Impact Strength | kJ/m² | 10.9 | 10.6 | 9.5 | 6.9 |
| (Charpy, 23° C.) | | | | | |
| Melting Point [° C.] | ° C. | 173.2 | 172.7 | 171.5 | 171.1 |
| Enthalpie 2. Heating | J/g | 175.4 | 179.8 | 178.6 | 176.1 |
| Crystallinity | % | 53.8 | 55.2 | 54.8 | 54.0 |
| Crystallization Point | ° C. | 151.8 | 151.6 | 150.5 | 150.0 |
| [° C.] | | | | | |
| Area 1. Cooling | J/g | 177.3 | 180.5 | 182.5 | 180.6 |
| Onset [° C.] | ° C. | 152.4 | 152.3 | 151.2 | 151.1 |
| Coefficient of Friction | (F = 30N, | 0.32 | 0.31 | 0.24 | 0.28 |
| (vs. C9021) | v = 8 mm/s, | | | | |
| | t = 45 min) | | | | |
| Static Coefficient of | (F = 30N, | 0.50 | 0.49 | 0.45 | 0.47 |
| Friction (vs. C9021) | v = 8 mm/s, | | | | |
| | t = 45 min) | | | | |
| Wear (Plate vs. C9021) | mm | 1.90 | 2.06 | 1.62 | 1.82 |
| Wear (Ball, C9021) | mm | 2.02 | 2.08 | 1.58 | 1.59 |
| Wear (Plate vs. Steel, | mm | 4.58 | n.a. | 1.66 | n.a. |
| after 60 h) | | | | | |

Sample 3 additive containing stearyl end groups was then combined with a polyoxymethylene polymer having a melt volume flow rate of 8.9 ml/10 min. The additive was present in the final composition in an amount from about 10% to about 21% by weight. The following results were obtained:

TABLE 5

| | | Polyoxymethylene | +10.41 w.-% | +15.61 w.-% | +20.81 w.-% |
|---|---|---|---|---|---|
| Properties | Unit | Polymer Control | Sample 3 | Sample 3 | Sample 3 |
| MVR 190/2.16 kg | ml/10 min | 8.9 | 10.6 | 12.6 | 17.6 |
| Tensile Modulus | MPa | 2858.0 | 2868.0 | 2909.0 | 2892.0 |
| Tensile Yield Stress | MPa | 67.5 | 67.5 | 63.7 | 59.8 |
| Tensile Stress at break | MPa | 57.3 | 59.2 | 56.6 | 56.5 |
| Elongation at Yield | % | 10.2 | 9.0 | 8.8 | 7.4 |
| Nominal Elongation at | % | 35.2 | 29.3 | 29.4 | 19.0 |
| Break | | | | | |
| Notched Impact Strength | kJ/m² | 8.3 | 8.1 | 7.6 | 6.4 |
| (Charpy, 23° C.) | | | | | |
| Melting Point [° C.] | ° C. | 167.0 | 166.5 | 166.2 | 166.1 |
| Enthalpie 2. Heating | J/g | 165.3 | 170.3 | 167.5 | 173.4 |
| Crystallinity | % | 50.7 | 52.2 | 51.4 | 53.2 |
| Crystallization Point | ° C. | 149.3 | 149.5 | 149.3 | 150.0 |
| [° C.] | | | | | |
| Area 1. Cooling | J/g | 172.2 | 176.7 | 174.8 | 173.1 |
| Onset [° C.] | ° C. | 150.2 | 150.4 | 150.0 | 149.8 |
| Coefficient of Friction | (F = 30N, | 0.35 | 0.31 | 0.29 | 0.26 |
| (vs. C9021) | v = 8 mm/s, | | | | |
| | t = 45 min) | | | | |
| Static Coefficient of | (F = 30N, | 0.55 | 0.51 | 0.56 | 0.46 |
| Friction (vs. C9021) | v = 8 mm/s, | | | | |
| | t = 45 min) | | | | |
| Wear (Plate vs. C9021) | mm | 2.91 | 2.48 | 0.77 | 1.57 |
| Wear (Ball, C9021) | mm | 2.21 | 1.57 | 1.40 | 1.31 |
| Wear (Plate vs. Steel, | mm | 7.90 | n.a. | 5.29 | n.a. |
| after 60 h) | | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A process for producing a polyoxymethylene polymer comprising:
combining a monomer that forms —CH₂—O— units with a transfer agent and an initiator, the transfer agent comprising a Bis-alkylformal, the Bis-alkylformal including alkyl end groups having a linear or branched carbon chain length of at least 10 carbon atoms;
polymerizing the monomer while raising the temperature, the pressure, or both the temperature and pressure during polymerization an amount sufficient for the Bis-alkylformal to dissolve in the monomer, and wherein the Bis-alkylformal reacts during the polymerization such that the linear or branched alkyl end groups on the Bis-alkylformal form end groups on the polyoxymethylene polymer; and
adding a deactivator to deactivate the polymerization.

2. A process as defined in claim 1, wherein the formed polyoxymethylene polymer comprises a substantially homogeneous polymer melt when the deactivator is added.

3. A process as defined in claim 1, further comprising the step of degrading unstable chain ends on the formed polyoxymethylene polymer through hydrolysis.

4. A process according to claim 1, wherein the Bis-alkylformal has the following chemical structure: 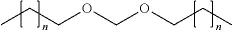
wherein n is from about 10 to about 150, such as from about 10 to about 80, such as from about 12 to about 60.

5. A process according to claim 1, wherein the Bis-alkylformal comprises Bis-stearylformal or Bis-eicosanylformal.

6. A process as defined in claim 1, wherein the Bis-alkylformal includes branched alkyl end groups.

7. A process according to claim 1, wherein at least about 80%, such as at least about 85%, such as at least about 90%, such as at least about 95% of the resulting polyoxymethylene polymer has the alkyl end groups having a linear or branched carbon chain length of at least 10 carbon atoms.

8. A process according to claim 1, wherein the monomer is also combined with a branching agent to form a branched polyoxymethylene polymer.

9. A process as defined in claim 8, wherein the branched polyoxymethylene polymer includes at least three terminal groups per molecule, such as from about three terminal groups to about six terminal groups per molecule.

10. A polyoxymethylene polymer comprising:
a polyoxymethylene homopolymer or a polyoxymethylene copolymer wherein greater than 80% of the polyoxymethylene homopolymer or copolymer includes long-chain alkyl end groups, the end groups having a linear or branched carbon chain having a carbon chain length of greater than 10 carbon atoms.

11. A polyoxymethylene polymer as defined in claim 10, wherein greater than 85%, such as greater than 90%, such as greater than 95% of the polyoxymethylene homopolymer or copolymer includes the long-chain alkyl end groups.

12. A polyoxymethylene polymer as defined in claim 10, wherein the long-chain alkyl end groups have the following formula: 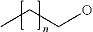
wherein n is from 10 to 150, such as from 12 to 80, such as from 12 to 60.

13. A polyoxymethylene polymer as defined in claim 10, wherein the polyoxymethylene homopolymer or copolymer comprises a branched polyoxymethylene homopolymer or copolymer such that the homopolymer or copolymer includes at least three terminal groups.

14. A polymer composition comprising:
a polyoxymethylene homopolymer or a polyoxymethylene copolymer that includes long-chain alkyl end groups, the end groups having a linear or branched carbon chain having a carbon chain length of greater than 10 carbon atoms, the polyoxymethylene polymer being present in the composition in an amount from about 40% to about 95% by weight, such as from about 40% to about 80% by weight.

15. A polymer composition comprising:
a thermoplastic polymer combined with a flow additive, the flow additive comprising a polyoxymethylene polymer with long-chain alkyl end groups, the alkyl end groups having a linear or branched carbon chain length of at least 10 carbon atoms, the polyoxymethylene polymer having a molecular weight of less than about 50,000 g/mol.

16. A polymer composition as defined in claim 15, wherein the polyoxymethylene polymer flow additive has a molecular weight of less than about 40,000 g/mol, such as less than about 30,000 g/mol, such as less than about 20,000 g/mol, such as less than about 15,000 g/mol.

17. A polymer composition as defined in claim 15, wherein the flow additive is present in the polymer composition in an amount from about 1% to about 50% by weight, such as in an amount from about 5% to about 30% by weight, such as in an amount from about 5% to about 15% by weight.

18. A polymer composition as defined in claim 15, wherein the thermoplastic polymer comprises a second polyoxymethylene polymer, the second polyoxymethylene polymer not including the long-chain alkyl end groups.

19. A polymer composition according to claim 15, wherein the long-chain alkyl end groups have the following formula: 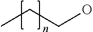
wherein n is from 10 to 150, such as from 12 to 80, such as from 12 to 60.

20. A polymer composition as defined in claim 15, wherein the polyoxymethylene homopolymer or copolymer comprises a branched polyoxymethylene homopolymer or copolymer.

21. An article molded from the polymer composition as defined in claim 15.

22. A polymer composition as defined in claim 15, wherein the flow additive is present in the polymer composition in an amount sufficient to increase the melt flow rate of the thermoplastic polymer by greater than about 10%, such as greater than about 20%, such as greater than about 30%, such as greater than about 40%, such as greater than about 50%, such as greater than about 60%.

23. A polymer composition as defined in claim 15, wherein the long-chain alkyl end groups comprise stearyl end groups.

24. A flow additive comprising:
a polyoxymethylene polymer with long-chain alkyl end groups, the alkyl end groups having a linear or branched carbon chain length of at least 10 carbon atoms, the polyoxymethylene polymer having a molecular weight of less than about 50,000 g/mol, the polyoxymethylene polymer containing the long-chain alkyl end groups in an amount of at least about 3% by weight.

25. A process for producing a formal comprising:
combining a long-chain alcohol having a hydrocarbon chain length of greater than about 10 carbon atoms with a formaldehyde source in the presence of a solvent to form a reaction mixture;
contacting the reaction mixture with a catalyst in order to form a Bis-formal while removing formed water; and
collecting the Bis-formal.

26. A process according to claim 25, further comprising the step of cooling the Bis-formal sufficiently for the Bis-formal to precipitate prior to collecting the Bis-formal.

27. A process as defined in claim 2, wherein the Bis-formal is produced according to the following reaction: 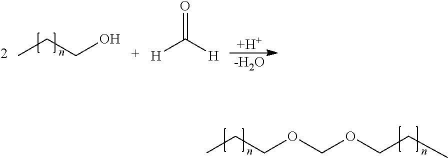
where n is from 12 to about 80.

28. A process as defined in claim 25, wherein the Bis-formal is produced according to the following reaction: 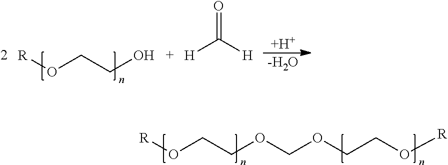
where n is from 10 from about 150 and R comprises H or an alkyl group.

29. A process for producing a Bis-alkylformal comprising:
combining an aliphatic alcohol having a hydrocarbon chain length of greater than 10 carbon atoms with a formaldehyde source in the presence of a solvent to form a reaction mixture;
contacting the reaction mixture with a catalyst in order to form a Bis-alkylformal while removing formed water; and
collecting the Bis-alkylformal.
